(19) United States
(12) Patent Application Publication
(10) Pub. No.: US 2026/0231013 A1
(43) Pub. Date: Aug. 6, 2026

(54) METHOD AND APPARATUS FOR HANDLING MINIMUM SYSTEM INFORMATION IN A WIRELESS COMMUNICATION SYSTEM

(71) Applicant: Samsung Electronics Co., Ltd., Suwon-si, Gyeonggi-do (KR)

(72) Inventors: Manasi EKKUNDI, Bangalore (IN); Neha SHARMA, Bangalore (IN); Dongmyoung KIM, Suwon-si (KR)

(21) Appl. No.: 19/150,436

(22) PCT Filed: Jan. 25, 2024
(86) PCT No.: PCT/KR2024/001216

§ 371 Date: Jul. 23, 2025

(30) Foreign Application Priority Data
Feb. 7, 2023 (IN) 202341007887
Jan. 16, 2024 (IN) 2023 41007887

(51) Int. Cl. H04W 48/20; H04W 74/0833; H04W 76/20; H04W 84/04

(52) U.S. Cl. CPC H04W 48/20; H04W 74/0833; H04W 76/20; H04W 84/042

(57) ABSTRACT

The disclosure relates to a 5G communication system or a 6G communication system for supporting higher data rates beyond a 4G communication system such as long term evolution (LTE). Various embodiments herein provide a method and a device for handling minimum system information MSI (904a) for a next generation telecommunication network. A User Equipment (UE) (111) tuning a frequency for cell selection in the PBCH network. The UE (111) receives a Physical Broadcast Channel (PBCH) (103g) block on the tuned frequency, broadcasted from a network apparatus (113) in the next-generation telecommunication network. Subsequently, the UE (111) decodes the PBCH (103g) block to extract the MSI (904a), comprising a Master Information Block (MIB) and a System Information Block (SIB). The SIB comprises, cell selection parameters, cell access-related parameters, a value tag indicating the validity of the MSI or any changes, and RACH parameters.

### TECHNICAL FIELD

The disclosure relates to the field of wireless communication system. More particularly proposed disclosure is related to a method for handling Minimum System Information (MSI) for a next generation telecommunication network.

### BACKGROUND ART

Considering the development of wireless communication from generation to generation, the technologies have been developed mainly for services targeting humans, such as voice calls, multimedia services, and data services. Following the commercialization of 5G (5 th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Re-configurable Intelligent Surface (RIS).

Moreover, in order to improve the spectral efficiency and the overall network per-formances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Over recent years, wireless communication technologies have undergone continuous improvements. The advent of Long-Term Evolution (LTE) and Fourth Generation (4G) networks revolutionized mobile communication by providing faster data speeds, reduced latency, and improved multimedia features. However, the increasing demand for data speeds and the number of users necessitates the development of an improved communication system that can achieve high data transmission rates by reducing latency. The 5G technology promises to offer lower latency compared to 4G, where latency refers to the time delay between initiating a process and its completion. In the context of technology and communication, it often represents the delay between sending and receiving data.

The 5G technology employs a sophisticated Multi-Radio Access Technology Dual Connectivity (MR-DC) to link the UE with the cell. This innovative technology allows the UE to connect to two different RATs and cells simultaneously, providing enhanced stability, low latency, and faster data rates for both upload and download speeds. MR-DC leverages the capabilities of both 4G and 5G connections, significantly improving download and upload speeds. Additionally, it offers intelligent load balancing based on network congestion, resource availability, and UE requirements, efficiently dividing traffic between the 4G and 5G connections. In MR-DC, two connections are used simultaneously, one with the 4G (eNB) and the other with the 5G (gNB).

The UE establishes a connection with the cell by acquiring the system information and attempting to detect the presence of a Synchronization Signal (SS) and at least one cell identification (ID) during the initial access phase. Once the UE is connected to a network and associated with a cell, it actively monitors neighboring cells by detecting the SS and/or measuring the associated cell-specific Reference Signals (RS).

With the advent of next-generation cellular systems, such as Third Generation Partnership-New Radio Access or Interface (3GPP-NR), which provide enhanced mobile broadband (eMBB), ultra-reliable low latency (URLLC), and massive machine-type communication (mMTC), there is a pressing need for an efficient and unified mechanism for radio resource acquisition or tracking. This mechanism must be capable of addressing diverse use cases with distinct coverage requirements and frequency bands.

Current solutions are often tailored for specific network and radio resource paradigms, and there is a desire for a seamless, low-latency solution that can be applied across different scenarios.

The 6G technology strives to attain an exceptionally low latency by executing streamlined and optimized procedures for disseminating system information to the UE, enabling it to select the cell. Through groundbreaking improvements in communication protocols, network architecture, and data processing, the 6G aims to achieve un-paralleled levels of ultra-low latency. The optimization of data transfer will greatly benefit applications such as real-time communication, critical services, and immersive experiences.

A device needs to receive system information message that contains the basic cell selection, reselection, acquisition parameters and configurations. System information is broadcast in case of Standalone (SA) mode of operation and in Non-Standalone (NSA) or MR-DC, the Secondary node (SN) is not required to broadcast the system information other than for radio frame timing and System frame number (SFN). System information for initial configuration is provided to a User Equipment (UE) by dedicated Radio Resource Control (RRC) signalling via a Master Node (MN). The UE acquires, at least, radio frame timing and the SFN of Secondary Cell Group (SCG) from the synchronization signals and Master Information Block (MIB) of the PsCell. Furthermore, in fourth generation technology, all system information was broadcast periodically in the cell while in the fifth generation technology, minimum SI messages are broadcast in the cell and there is an option to deliver the remaining SI on demand.

It is required to hence define the System Information handling, contents, procedures and systems in the future 6G network architecture options considering the new re-quirements, services and optimization goals in 6G.

Thus, it is desired to address the above-mentioned disadvantages or other shortcomings or at least provide a useful alternative to overcome the handling of the minimum system information in the telecommunication system.

The principal object of the embodiments herein is to provide a method for handling MSI for a next generation telecommunication network. The present solution includes an efficient and reliable procedure for a UE to establish communication with a cell or Secondary Node (SN) and receive MSI, which comprises a Master Information Block (MIB) and a System Information Block (SIB) in a Standalone Network (SA) or a MR-DC from the designated SN. The devised system streamlines the process of processing and distributing MSI from the network node to the UE, thereby curtailing the number of steps involved. In 6G, the Physical Broadcast Channel (PBCH) capacity is expected to be augmented to accommodate more data packets in terms of MSI and disseminate the same through the PBCH. Consequently, the latency would be minimized by reducing the number of steps in the process of sharing MSI with the UE.

Another object of the embodiments herein is streamline the inter-node communication process between the Master Node (MN) and the Secondary Node (SN) within the MR-DC. Specifically, the aim is to enable the SN to directly transmit the Minimum System Information (MSI) to the User Equipment (UE) in a single step, without the need for an intermediate node such as the MN.

Yet another object of the embodiments herein is handling the modifications to the MSI without relinquishing the chosen SN and to communicate changes in the altered MSI through a singular bit indication.

Yet another object of the embodiments herein is to enable the reselection of an Inter-Radio Access Technology (IRAT) for the sixth-generation Radio Access Technology (RAT) through a modified System Information Block (SIB) containing 6G data in both LTE and 5G networks.

Yet another object of the embodiments herein is to address the management of SI changes in MR-DC systems. This is achieved through the utilization of a singular bit indicator that signals alterations in SI acquisition. The decoding of system information from the SSB block allows for the attainment of the minimum SI required.

Yet another object of the embodiments herein is to add Information elements that encompass 6G RAT information into various signaling messages, such as, LTE SIB for IRAT reselection parameters, NR SIB for IRAT reselection parameters, LTE SIB for SN information, NR SIB for SN information, and 6G SIB, which are exclusive to this advanced technology.

### DISCLOSURE OF INVENTION

### Solution to Problem

In an aspect, the objectives are achieved by handling the MSI for a next generation telecommunication network like 6G. The method includes tuning, by the UE, a frequency to perform cell selection in the next generation telecommunication network. Further, the method includes receiving, by the UE, a PBCH block on the tuned frequency, wherein the PBCH block is broadcasted from a network apparatus in the next generation telecommunication network. Furthermore, the method includes decoding, by the UE, the PBCH block to obtain the MSI, wherein the MSI comprises components of MIB and a SIB, wherein the SIB comprises at least one of the at least one cell selection parameter, at least one cell access related parameter, a value tag indicating whether the MSI is valid or a change has occurred, and at least one Random-Access Channel (RACH) parameter. Thereafter, the method includes, performing, by the UE, the cell selection on the tuned frequency to select at least one candidate cell based on the at least one cell selection parameter, the at least one cell access related parameter, the value tag and the at least one RACH parameter.

In various embodiments, the method of performing the cell selection on the tuned frequency to select the at least one candidate cell comprises determining whether the at least one candidate cell is barred based on the at least one cell selection parameter, the at least one cell access related parameter, the value tag, and the at least one RACH parameter. Further, the method includes retuning the frequency to perform the cell selection, when the at least one candidate cell is barred. Thereafter, the method includes performing the cell selection on the retuned frequency to select the at least one candidate cell, when the cell is not barred.

In various embodiments, performing the cell selection is on the tuned frequency to select the at least one candidate cell comprises detecting the candidate cell based on the at least one cell access related parameter, the at least one cell selection parameter, the value tag, and the at least one RACH parameter. Further, the method includes retuning the frequency to perform the cell selection, when the candidate cell is not detected. Thereafter, the method includes selecting the at least one candidate cell, when the at least one candidate cell corresponding to the cell is detected.

In various embodiments, decoding the PBCH block to obtain the MSI comprises determining a Physical Cell Identifier (PCI) of a cell based on the decoded SS and decoding the PBCH block to obtain the MSI based on the PCI of the cell.

In various embodiments, the method includes at least one cell selection related parameter indicates cell selection threshold values required for the UE to check whether the UE meets the minimum cell selection criteria, wherein the at least one cell access related parameter indicates access information of the at least one of a PLMN, an area code, and a cell identifier, and wherein the at least one value TAG parameter comprises a value tag indicating whether a MSI is valid or a change has occurred, and the at least one RACH parameter indicating a RACH configuration required for the UE to perform the RACH.

In various embodiments, the method includes a RRC configuration request message comprises information of the at least one candidate cell added into the next generation telecommunication network by the network apparatus.

In various embodiments, the method receiving the RRC configuration request message for the cell selection from a MN, wherein the MN is connected to the network apparatus when the UE comprises a dual connectivity capability. Further, the method includes, receiving the MSI on the PBCH broadcast by the SN of the next generation telecommunication network. Further, the method includes sending a RRC configuration complete message to the MN in the network after the cell selection.

In various embodiments, the method includes the next generation telecommunication network is a 6G telecommunication network and an advanced telecommunication network.

Accordingly, the embodiment herein is to provide a method for handling the MSI in a next generation telecommunication network. The MN receiving a measurement report from the UE for adding at least one candidate cell in the next generation telecommunication network. The method includes, sending a candidate cell addition request message to the network apparatus in the next generation telecommunication network. The method includes, receiving a candidate cell addition response message from the network apparatus after addition of the at least one candidate cell in the next generation telecommunication network, while the network apparatus continues to broadcast the PBCH block combining the MSI to the UE, wherein the MSI comprises the MIB and the SIB, wherein the SIB comprises the at least one of at least one cell selection parameter of the at least one candidate cell, the at least one cell access related parameter of the at least one candidate cell, a value tag indicating whether the MSI is valid or a change has occurred, and the at least one RACH parameter of the at least one candidate cell. The method includes, sending the RRC configuration request message to the UE, wherein the RRC configuration request message comprises the information of the candidate cell added into the next generation telecommunication network. The method includes, receiving a RRC configuration complete message from the UE in the next generation telecommunication network after completion of cell selection by the UE.

In various embodiments, the cell addition response message comprises information of the candidate cell added into the next generation telecommunication network, and wherein the cell addition response message does not comprises the SIB as the MSI is already broadcasted by the network apparatus.

In various embodiments, receiving a cell modification request message from the cell to modify the at least one candidate cell. Further, the method includes, initiating a cell modification procedure corresponding to the at least one candidate cell based on the cell modification request message. Further, the method includes, sending a RRC reconfiguration message for the cell reselection after the cell modification, wherein the RRC reconfiguration message comprises one bit information indicating a change in system information corresponding to the at least one candidate cell, wherein the change in the system information indicates availability of the MSI on the PBCH block to enable the UE to directly read the MSI. Further, the method includes, receiving a RRC reconfiguration complete message from the UE. Thereafter, the method includes, sending a cell modification response message to the cell.

Accordingly, the embodiment herein is to provide a method for handling the MSI in a next generation telecommunication network. The method includes, the network apparatus broadcasting the PBCH block comprising the MSI to the UE in the next generation telecommunication network. Further, the method includes, receiving a cell addition request message from the at least one cell in the next generation telecommunication network. Further, the method includes, adding at least one candidate cell in the next generation telecommunication network based on the cell addition request message. Further, the method includes, sending a cell addition response message to the cell after addition of the at least one candidate cell in the next generation telecommunication network. Further, the method includes, sending the PBCH block comprising the MSI directly to the UE, wherein the MSI comprises the MIB and the SIB, wherein the SIB comprises the at least one of at least one cell selection parameter of the at least one candidate cell, the at least one cell access related parameter of the at least one candidate cell, a value tag indicating whether the MSI is valid or a change has occurred, and the at least one RACH parameter of the at least one candidate cell.

In various embodiments, the cell addition response message comprises information of the candidate cell added into the next generation telecommunication network, and wherein the cell addition response message does not comprises the SIB as the MSI is already broadcasted by the cell.

In various embodiments, the network apparatus sending the cell modification request message to the network apparatus to modify the at least one candidate cell. Further, the method includes, imitating a cell modification procedure corresponding to the at least one candidate cell based on the cell modification request message. Further, the method includes, receiving a cell modification response message from the at least one of the cell.

In various embodiments, network apparatus generating the SIB message comprising a next generation RAT information for IRAT cell reselection with next generation frequencies and next generation neighbouring cell information. Further, sending the SIB message including at least one neighbour cell of the network apparatus in the next generation telecommunication network.

In various embodiments, the next generation RAT information is a 6G RAT information, wherein the next generation frequencies is 6G frequencies, and wherein next the generation neighboring cell information is 6G neighboring cell information, and wherein the at least one neighbor cell is one of 3G cell, 4G cell, and 5G cell.

Accordingly, the embodiment herein is to provide the UE for handling system information in a next generation telecommunication network. The UE comprises a memory, a processor and a system information controller is communicatively coupled to the memory and the processor. The UE tune a frequency to perform cell selection in the next generation telecommunication network. Further, receive the PBCH block on the tuned frequency, wherein the PBCH block is broadcasted from the network apparatus in the next generation telecommunication network. Further, decode the PBCH block to obtain the MSI, wherein the MSI comprises the MIB and the SIB, wherein the SIB comprises the at least one of at least one cell selection parameter, the at least one cell access related parameter, a value tag indicating whether the MSI is valid or a change has occurred, and the at least one RACH parameter. Further, perform the cell selection on the tuned frequency to select at least one candidate cell based on the at least one cell selection parameter, the at least one cell access related parameter, the value tag and the at least one RACH parameter.

Accordingly, the embodiment herein is to provide the network apparatus for handling system information in a next generation telecommunication network. The network apparatus comprises a memory, a processor and a system information controller, communicatively coupled to the memory and the processor configured to broadcast the PBCH block comprising the MSI to the UE in the next generation telecommunication network. Further, receive a cell addition request message from the at least one cell in the next generation telecommunication network. Further, add at least one candidate cell in the next generation telecommunication network based on the cell addition request message. Furthermore, send a cell addition response message to the cell after addition of the at least one candidate cell in the next generation telecommunication network. Thereafter, send the PBCH block comprising the MSI directly to the UE, wherein the MSI comprises the MIB and the SIB, wherein the SIB comprises at least one of the at least one cell selection parameter of the at least one candidate cell, the at least one cell access related parameter of the at least one candidate cell, a value tag indicating whether the MSI is valid or a change has occurred, and the at least one RACH parameter of the at least one candidate cell.

Accordingly, the embodiment herein is to provide a MN for handling system information in a next generation telecommunication network. The MN comprises a memory, a processor and a system information controller, communicatively coupled to the memory and the processor. The system information controller is configured to receive a measurement report from the UE for adding at least one candidate cell in the next generation telecommunication network. Further, send a candidate cell addition request message to the network apparatus in the next generation telecommunication network. Further, receive a candidate cell addition response message from the network apparatus after addition of the at least one candidate cell in the next generation telecommunication network, while the network apparatus continues to broadcast the PBCH block combining the MSI to the UE, wherein the MSI comprises the MIB and the SIB, wherein the SIB comprises at least one of the at least one cell selection parameter of the at least one candidate cell, the at least one cell access related parameter of the at least one candidate cell, a value tag indicating whether the MSI is valid or a change has occurred, and the at least one RACH parameter of the at least one candidate cell. Furthermore, send the RRC configuration request message to the UE, wherein the RRC configuration request message comprises the information of the candidate cell added into the next generation telecommunication network. Thereafter, receive a RRC configuration complete message from the UE in the next generation telecommunication network after completion of cell selection by the UE.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

These and other features, aspects, and advantages of the embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates the control plane and user plane in MR-DC, according to the prior art as disclosed herein;

FIG. 2 is a detailed block diagram that illustrates the transmission of system information, according to the prior art as disclosed herein;

FIG. 3A is a block diagram that illustrates the user equipment in minimum system information broadcast, according to the prior art as disclosed herein;

FIG. 3B is a block diagram that illustrates network apparatus operating in minimum system information broadcast, according to the prior art as disclosed herein;

FIG. 3C is a block diagram that illustrates the master node in minimum system information broadcast, according to the prior art as disclosed herein;

FIG. 4 depicts a sequence diagram that illustrates a process of system information acquisition method in EN-DC, according to the prior art as disclosed herein;

FIG. 4A depicts a sequence diagram that illustrates a process of handling system information change in MR-DC, according to the prior art as disclosed herein;

FIG. 5 is a block diagram that illustrates 6G Baseline Architecture option(s), according to the prior art as disclosed herein;

FIG. 6 is a flow chart that illustration the acquisition of minimal system information in SA within NR, according to the prior art as disclosed herein;

FIG. 7 is a block diagram that illustrates sharing of master information block in 5G, according to the prior art as disclosed herein;

FIG. 8A is a block diagram that illustrates channel mapping of system information in the 5G, according to the prior art as disclosed herein;

FIG. 8B is a flow chart that illustrates acquisition of the minimum system information in SA in the 6G, according to the embodiment as disclosed herein;

FIG. 9 is a block diagram that illustrates sharing of the minimum system information in the 6G through PBCH, according to the embodiment as disclosed herein;

FIG. 10 is a block diagram that illustrates channel mapping of the system information in the 6G, according to the embodiment as disclosed herein;

FIG. 11 depicts a sequence diagram that illustrates a process of acquiring the minimum system information in the MR-DC, according to the embodiment as disclosed herein;

FIG. 12 depicts a sequence diagram that illustrates the call flow for the system information change, according to the embodiment as disclosed herein;

FIG. 13A illustrates secondary node information in the LTE for the 6G RAT, according to the embodiment as disclosed herein;

FIG. 13B illustrates secondary node information in 5G for the 6G RAT, according to the embodiment as disclosed herein;

FIG. 14A a flow diagram that illustrates a method for handling minimum system information by user equipment, according to the embodiment as disclosed herein;

FIG. 14B a flow diagram that illustrates a method for handling minimum system information by MN, according to the embodiment as disclosed herein;

FIG. 14C a flow diagram that illustrates a method for handling minimum system information by network apparatus, according to the embodiment as disclosed herein;

FIG. 15 a depicts a sequence diagram that illustrates the system information sharing in the SA, according to the embodiment as disclosed herein;

FIG. 16 is a structure of a user equipment according to the embodiments.

FIG. 17 is a structure of a base station according to the embodiments.

FIG. 18 is a structure of a network entity according to the embodiments.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### Mode for the Invention

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments discloses a method for handling minimum system information (MSI) for a next generation telecommunication network. The method includes tuning, by the UE, a frequency to perform cell selection in the next generation telecommunication network. Further, the method includes receiving, by the UE, a Physical Broadcast Channel (PBCH) block on the tuned frequency, wherein the PBCH block is broadcasted from a network apparatus in the next generation telecommunication network. Furthermore, the method includes decoding, by the UE, the PBCH block to obtain the MSI, wherein the MSI comprises the MIB and the SIB, wherein the SIB comprises at least one of the at least one cell selection parameter, the at least one cell access related parameter, a value tag indicating whether the MSI is valid or a change has occurred, and the at least one RACH parameter. Thereafter, the method includes, performing, by the UE, the cell selection on the tuned frequency to select at least one candidate cell based on the at least one cell selection parameter, the at least one cell access related parameter, the value tag and the at least one RACH parameter.

Accordingly, the embodiment herein is to provide a method for handling the MSI in a next generation telecommunication network. The MN receiving a measurement report from the UE for adding at least one candidate cell in the next generation telecommunication network. The method includes, sending a candidate cell addition request message to a network apparatus in the next generation telecommunication network. The method includes, receiving a candidate cell addition response message from the network apparatus after addition of the at least one candidate cell in the next generation telecommunication network, while the network apparatus continues to broadcast the PBCH block combining the MSI to the UE, wherein the MSI comprises the MIB and the SIB, wherein the SIB comprises at least one of the at least one cell selection parameter of the at least one candidate cell, the at least one cell access related parameter of the at least one candidate cell, a value tag indicating whether the MSI is valid or a change has occurred, and the at least one RACH parameter of the at least one candidate cell. The method includes, sending the RRC configuration request message to the UE, wherein the RRC configuration request message comprises the information of the candidate cell added into the next generation telecommunication network. The method includes, receiving a RRC configuration complete message from the UE in the next generation telecommunication network after completion of cell selection by the UE.

Accordingly, the embodiment herein is to provide a method for handling the MSI in a next generation telecommunication network. The method includes, a network apparatus broadcasting the PBCH block comprising the MSI to the UE in the next generation telecommunication network. Further, the method includes, receiving a cell addition request message from the at least one cell in the next generation telecommunication network. Further, the method includes, adding at least one candidate cell in the next generation telecommunication network based on the cell addition request message. Further, the method includes, sending a cell addition response message to the cell after addition of the at least one candidate cell in the next generation telecommunication network. Further, the method includes, sending the PBCH block comprising the MSI directly to the UE, wherein the MSI comprises the MIB and the SIB, wherein the SIB comprises at least one of the at least one cell selection parameter of the at least one candidate cell, the at least one cell access related parameter of the at least one candidate cell, a value tag indicating whether the MSI is valid or a change has occurred, and the at least one RACH parameter of the at least one candidate cell.

The UE for handling system information in a next generation telecommunication network. The UE includes a memory, a processor, and a system information controller, communicatively coupled to the memory and the processor configured to tune a frequency to perform cell selection in the next generation telecommunication network. The UE receives the PBCH block on the tuned frequency. The PBCH block is broadcasted from the network apparatus. The UE decodes the PBCH block to obtain the MSI. The MSI comprises a Master Information Block (MIB) and a System Information Block (SIB). The SIB comprises at least one cell selection parameter, at least one cell access related parameter, a value tag indicating whether the MSI is valid or a change has occurred, and at least one RACH parameter. The UE performs the cell selection on the tuned frequency to select at least one candidate cell based on the at least one cell selection parameter, at least one cell access related parameter, the value tag and the at least one RACH parameter.

The network apparatus for handling system information in a next generation telecommunication network. The network apparatus includes a memory, a processor, and a system information controller communicatively coupled to the memory and the processor configured to broadcast the PBCH (103g) block comprises the MSI (904a) to the UE. The network apparatus receives a cell addition request message for at least one cell in the next generation telecommunication network. The network apparatus adds at least one candidate cell in the next generation telecommunication network based on the cell addition request message. The network apparatus sends a cell addition response message to the cell after addition of the at least one candidate cell. The network apparatus sends the PBCH block comprising the MSI directly to the UE. The MSI comprises the MIB and the SIB. The SIB comprises at least one cell selection parameter of the at least one candidate cell, at least one cell access related parameter of the at least one candidate cell, a value tag indicating whether the MSI is valid or a change has occurred, and at least one RACH parameter of the at least one candidate cell.

The MN for handling system information in a next generation telecommunication network including the memory, the processor, and the system information controller communicatively coupled to the memory and the processor. The MN receives the measurement report from the UE for adding at least one candidate cell in. The MN sends the candidate cell addition request message to the network apparatus. The MN receives the candidate cell addition response message from the network apparatus after addition of the at least one candidate cell in the next generation telecommunication network, while the network apparatus continues to broadcast the PBCH block combining the MSI to the UE. The MSI comprises the MIB and the SIB. The SIB comprises the at least one of at least one cell selection parameter of the at least one candidate cell, the at least one cell access related parameter of the at least one candidate cell, the value tag indicating whether the MSI is valid or a change has occurred, and the at least one RACH parameter of the at least one candidate cell. The MN sends the RRC configuration request message to the UE. The RRC configuration request message comprises the information of the candidate cell added into the next generation telecommunication network. The MN receives the RRC configuration complete message from the UE in the next generation telecommunication network after completion of cell selection by the UE.

In the existing system, the transmission of synchronization signals, comprising the Primary Synchronization Signal (PSS), Secondary Synchronization Signal (SSS), MIB, and SIB, from a SN to a UE involves a series of sequential steps. This, in turn, results in an associated latency at each stage, leading to delays in the acquisition of the MSI. The current process entails multiple steps and nodes for transmitting system information from the SN to the MN, utilizing several network (NW) elements and resources. To ensure a seamless transfer of the MSI, a closely integrated inter-working relationship between the MN and SN is imperative.

In the current context, the alteration of the MSI is managed in conjunction with the SN and the MN. This modification necessitates a reconfiguration with synchronization procedures to disseminate the updated MSI to the UE from the SN. To receive the revised SI, a reconfiguration with synchronization procedure must be executed, requiring inter-node message transfers first between the MN and SN, followed by the transmission of the updated MSI to the UE via SN dedicated RRC signaling.

The proposed solution aims to enhance efficiency, reduce latency, optimize network resource utilization, and leverage the potential capabilities of 6G technology to support larger MSI storage and sharing with the UE through the PBCH channel. The MSI, which includes MIB and required System Information (SI), is contained in a single SSB block, rather than being configured separately via dedicated RRC signaling or through the PDSCH channel.

The modification of the MSI is managed by the SN, which reconfigures with synchronization procedures. An SN Modification-RRC Reconfig of the MN indicates a modified MSI through a single bit indication. The procedure involves initial inter-node message transfers between the MN and SN, followed by the transmission of the updated MSI to the UE through the SN.

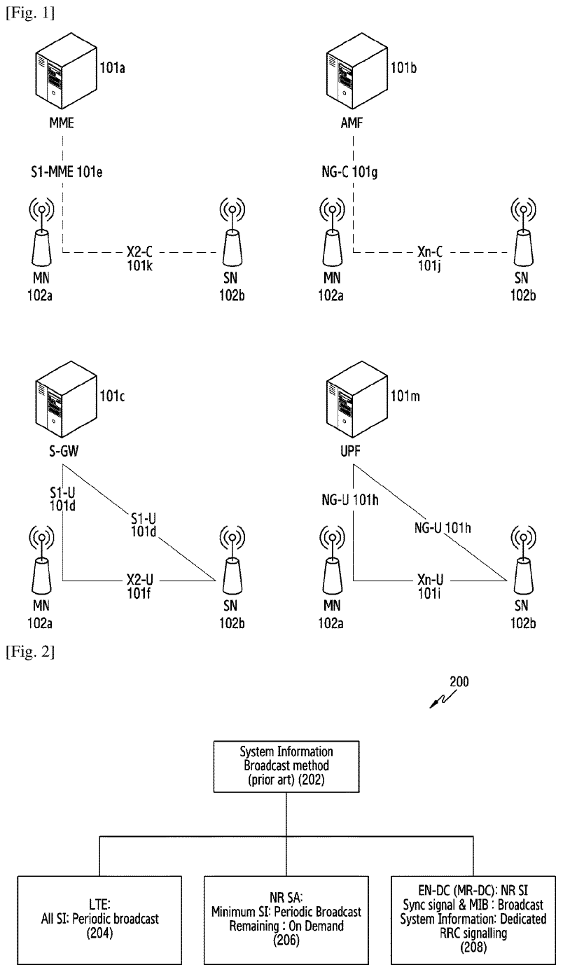

FIG. 1 is a block diagram that illustrates the control plane and user plane in MR-DC, according to the prior art as disclosed herein. The MR-DC technology allows for si-multaneous connectivity of the UE (302) to two distinct nodes, providing superior data rates, reduced latency, and improved reliability during network transitions. As depicted in FIG. 1, the MR-DC is EUTRA Dual Connectivity that employs multiple receivers and/or transmitters to utilize resources over two different nodes through a non-ideal backhaul. In FIG. 1 a MN (102a) and a SN (102b). The MN (102a) and the SN (102b), which are interconnected through a network interface, with at least the MN (102a) connected to the core network.

In the control plane, the interface establishes control plane signaling and coordination between the MN (102a) and the SN (102b). The UE (302) is associated with a control plane connection established between the MN (102a) and a corresponding Core Network (CN) entity. In the MR-DC configuration with Evolved Packet Core (EPC), denoted as EN-DC, the relevant core network entity is the Mobility Management Entity (MME) (101a). A S1-MME (101e) interface is terminated in the MN (102a), and interconnection between the MN (102a) and the SN (102b) is established through an X2-C (101k) interface. In the 5th Generation Core Network (5GC), which can be Next-Generation Dual Connectivity (NGEN-DC), Non-Standalone Dual Connectivity (NE-DC), or New Radio Dual Connectivity (NR-DC) and core network entity involved in an Access and Mobility Management Function (AMF) (101b). A NG-C (101g) interface is terminated in the MN (102a), with interconnection between the MN (102a) and the SN (102b) achieved through An Xn-C (101j) interface.

In the user plane of the MR-DC with Evolved Packet Core (EPC), a X2-U (101f) interface serves as the user plane interface between the MN (102a) and the SN (102b), while a S1-U (101d) interface functions as the user plane interface between the MN (102a), the SN (102b), or both, and a Serving Gateway (S-GW) (101c). In the MR-DC configurations, the 5th Generation Core Network (5GC) is at least one of the Next-Generation Dual Connectivity (NGEN-DC), the Non-Standalone Dual Connectivity (NE-DC), and the New Radio Dual Connectivity (NR-DC), and the core network entity involved in the Access and Mobility Management Function (AMF). The bearer connections in the MN (102a) utilize a Master Cell Group (MCG) for MCG radio resources, a Secondary Cell Group (SCG) for SCG radio resources, and split bearers that utilize both the MCG and SCG radio resources. In the user plane of the MR-DC, an Xn-U (101i) interface serves as the user plane interface between the MN (102a) and the SN (102b), while a NG-U (101h) interface functions as the user plane interface between the MN (102a), the SN (102b), or both, and a UPF (101m).

FIG. 2 is a detailed block diagram that illustrates the transmission of system information, according to the prior art as disclosed herein. The block diagram (200) showcases the System Information (SI) periodic broadcast in the LTE (204), a NR Standalone (SA) (206), EN-DC (MR-DC)-NR SI (208). The SI periodic broadcast in the LTE (204), the complete SI is periodically broadcasted (204) to the UE (302), sharing network-related information. The SI (202) is disseminated by the LTE SI periodic broadcasts (204) to the connected UE (302) within its coverage area, facilitating access and connection to the LTE all SI periodic broadcast (204).

Several key aspects of system information sharing in LTE all SI periodic broadcast (204) are noteworthy. The SI (202) is broadcasted periodically to ensure that the UE (302) receives updated information about the network.

In 5G New Radio (NR) Standalone (SA) (206), the network information is shared through the periodic broadcasting of the MSI. The MSI is encapsulated in the MIB (704) and broadcasted at regular intervals on the PBCH (702). The MIB (704) includes details of system bandwidth frame configuration and the identity of the cell. The periodic broadcast ensures that the UE (302) within the network's coverage area remains synchronized and acquires the MSI for access and connection establishment.

The 5G NR SA (206) provides on-demand sharing of additional or more detailed information. The on-demand broadcast allows the UE (302) to selectively request SI as needed, minimizing unnecessary signaling and optimizing resource utilization within the network. By enabling the UE (302) to retrieve information on demand, the system enhances efficiency.

In a 5G NR with E-UTRA-NR Dual Connectivity (EN-DC) or Multi-Radio Dual Connectivity (MR-DC) NR SI (208), a Synchronization Signal (SS) and the MIB (704) are the system information framework. The SS and the MIB (704) are broadcasted to the UE (302), ensuring proper configuration and synchronization of the UEs with the network apparatus. The MIB (704), including network apparatus parameters, such as network bandwidth and configuration, is broadcasted periodically on the PBCH (702), confirming that the UEs can access the SI for network synchronization and initial access.

The SI (202) in the EN-DC (MR-DC) NR SI (208) depends on a dedicated RRC. The SI (202) includes additional network details and configurations shared through the dedicated RRC, delivering more customized information to the UE (302). The use of dedicated RRC enhances the flexibility of the system, enabling the network to efficiently communicate the detailed SI to the UE (302) based on the UE (302) re-quirements.

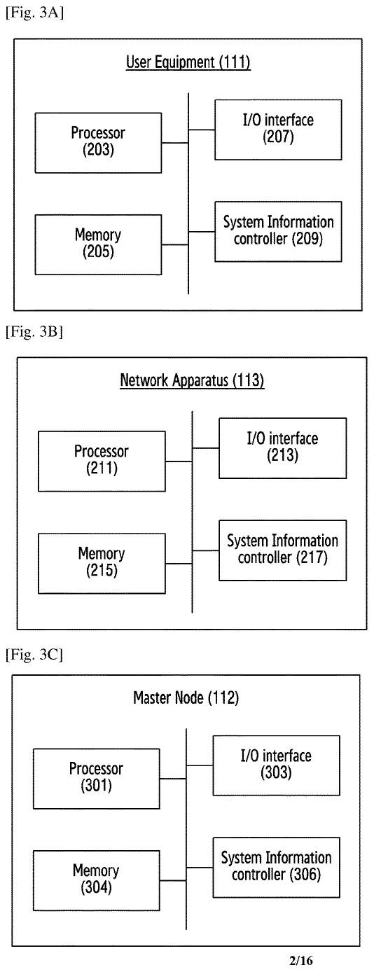

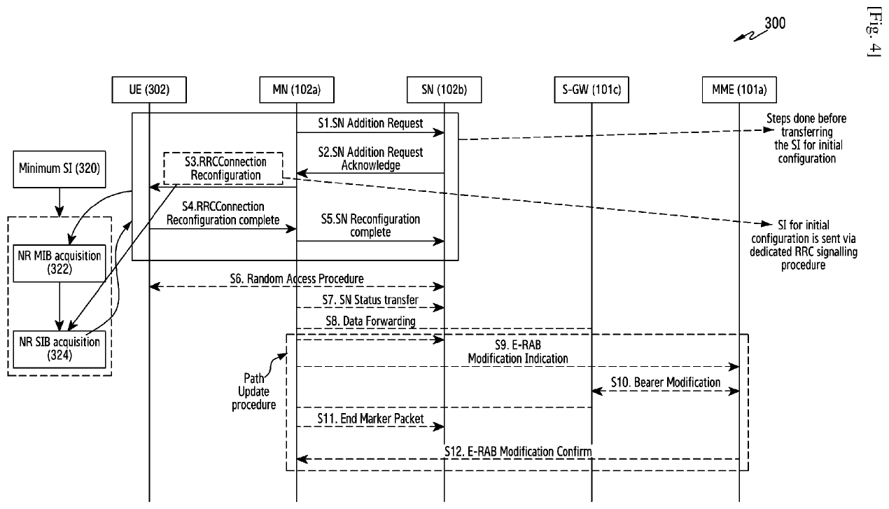

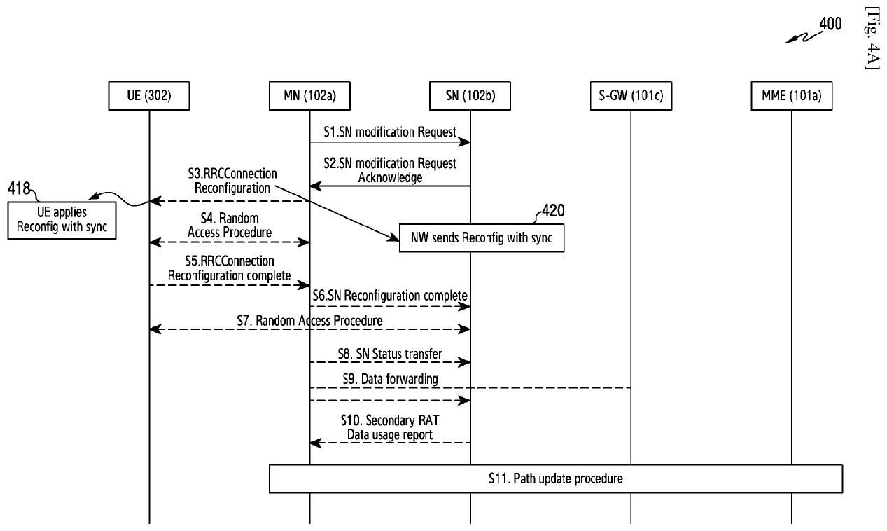

FIG. 3A is a block diagram that illustrates the user equipment in minimum system information broadcast. The UE (111) includes a processor (203), an I/O interface (207), a memory (205) and a System Information Controller (209). The analog and/or digital circuits such as logic gates, integrated circuits, microprocessors, microcontrollers, memory circuits, passive electronic components, active electronic components, optical components, hardwired circuits and the like are implemented. The processor (203) of the UE (111) communicates with the memory (205), the I/O interface (207) and the System Information Controller (209). The processor (203) executes instructions stored in the memory (205) and to perform various processes. The processor (203) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (205) of the UE (111) includes storage locations to be addressable through the processor (203). The memory (205) is not limited to a volatile memory and/or a non-volatile memory. Further, the memory (205) can include one or more computer-readable storage media. The memory (205) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (205) can store the media streams such as audios stream, video streams, haptic feedbacks and the like.

The I/O interface (207) transmits the information between the memory (205) and external peripheral devices. The peripheral devices are the input-output devices associated with the network apparatus (113). The I/O interface (207) receives several information from plurality of electronic devices. The System Information Controller (209) of the UE (111) tunes a frequency to perform cell selection in the next generation telecommunication network. Further, the UE (111) receives the PBCH (103g) block on the tuned frequency. The PBCH (103g) block is broadcasted from a network apparatus (113). Further, the UE (111) decodes the PBCH (103g) block to obtain the MSI (904a). The MSI (904a) comprises the MIB and the SIB. The SIB includes at least one of at least one cell selection parameter, at least one cell access related parameter, a value tag indicating whether the MSI is valid or a change has occurred, and at least one RACH parameter. Thereafter, the UE (111) performs the cell selection on the tuned frequency to select at least one candidate cell based on the at least one cell selection parameter, the at least one cell access related parameter, the value tag and the at least one RACH parameter.

FIG. 3B is a block diagram that illustrates network apparatus operating in minimum system information broadcast. In this scenario the Network Apparatus is the next generation node which can be in Standalone or NSA operation (113). The network apparatus (113) includes a processor (211), an I/O interface (213), a memory (215) and a System Information Controller (217). The analog and/or digital circuits such as logic gates, integrated circuits, microprocessors, microcontrollers, memory circuits, passive electronic components, active electronic components, optical components, hardwired circuits and the like are implemented. The processor (211) of the network apparatus (113) communicates with the memory (215), the I/O interface (213) and the System Information Controller (217). The processor (211) executes instructions stored in the memory (215) and to perform various processes. The processor (211) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (215) of the network apparatus (113) includes storage locations to be addressable through the processor (211). The memory (215) is not limited to a volatile memory and/or a non-volatile memory. Further, the memory (215) can include one or more computer-readable storage media. The memory (215) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (215) can store the media streams such as audios stream, video streams, haptic feedbacks and the like.

The I/O interface (213) transmits the information between the memory (215) and external peripheral devices. The peripheral devices are the input-output devices associated with the network apparatus (113). The I/O interface (213) receives several information from plurality of electronic devices. The System Information Controller (217) of the network apparatus (113) broadcasts the PBCH (103g) block comprising the MSI (904a) to the UE (111) in the next generation telecommunication network. The network apparatus (113) receives the cell addition request message from the at least one cell in the next generation telecommunication network. Further, the network apparatus (113) adds at least one candidate cell in the next generation telecommunication network based on the cell addition request message. Further, the network apparatus (113) sends the cell addition response message to the cell after addition of the at least one candidate cell in the next generation telecommunication network. Further, the network apparatus (113) sends the PBCH (103g) block comprises the MSI (904a) directly to the UE (111). The MSI (904a) comprises the MIB and the SIB. The SIB comprises at least one of at least one cell selection parameter of the at least one candidate cell, the at least one cell access related parameter of the at least one candidate cell, the value tag indicating whether the MSI is valid or the change has occurred, and the at least one RACH parameter of the at least one candidate cell.

FIG. 3C is a block diagram that illustrates the master node in minimum system information broadcast, according to the prior art as disclosed herein. The MN (112) includes a processor (301), an I/O interface (303), a memory (304) and a System Information Controller (306). The analog and/or digital circuits such as logic gates, integrated circuits, microprocessors, microcontrollers, memory circuits, passive electronic components, active electronic components, optical components, hardwired circuits and the like are implemented. The processor (301) of the MN (112) communicates with the memory (304), the I/O interface (303) and the System Information Controller (306). The processor (301) executes instructions stored in the memory (304) and to perform various processes. The processor (301) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (304) of the MN (112) includes storage locations to be addressable through the processor (301). The memory (304) is not limited to a volatile memory and/or a non-volatile memory. Further, the memory (304) can include one or more computer-readable storage media. The memory (304) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (304) can store the media streams such as audios stream, video streams, haptic feedbacks and the like.

The I/O interface (303) transmits the information between the memory (304) and external peripheral devices. The peripheral devices are the input-output devices associated with the MN (112). The I/O interface (303) receives several information from plurality of electronic devices. The System Information Controller (306) of the MN (112) receives a measurement report from the UE (111) for adding the at least one candidate cell. Further, the MN (112) sends the candidate cell addition request message to the network apparatus (113). Further, the MN (112) receives the candidate cell addition response message from the network apparatus (113) after addition of the at least one candidate cell in the next generation telecommunication network. Furthermore, the network apparatus (113) continues to broadcast the PBCH (103g) block combining the MSI (904a) to the UE (111). The MSI (904a) comprises the MIB and the SIB. The SIB comprises the at least one cell selection parameter of the at least one candidate cell, the at least one cell access related parameter of the at least one candidate cell, the value tag indicating whether the MSI is valid or a change has occurred, and the at least one RACH parameter of the at least one candidate cell. Furthermore, the MN (112) sends the Radio Resource Control (RRC) configuration request message to the UE (111). The RRC configuration request message comprises the information of the candidate cell added into the next generation telecommunication network. Thereafter, the MN (112) receives the RRC configuration complete message from the UE (111) in the next generation telecommunication network after completion of cell selection by the UE (111).

FIG. 4 depicts a sequence diagram that illustrates a process of system information acquisition method in EN-DC, according to the prior art as disclosed herein. The diagram showcases the UE (302), the MN (102a), the SN (102b), the Serving Gateway (S-GW) (101c), and the Mobility Management Entity (MME) (101a). At the outset, as illustrated in FIG. 4, the MN (102a) initiates the process by sending a SN Addition Request to the SN (102b), which includes the UE (302) capabilities, the UE (302) capability coordination result, the latest measurement result of the cell shared to the SN (102b) to choose, and security information. The SN (102b) then responds with a SN Addition Request Acknowledge, which includes radio resources configuration, additional information of the decided cell to share, the additional information in the MSI (320), and the radio resource configuration to the MN (102a).

Once the SN (102b) accepts the SN Addition Request and shares all the addition information with the MN (102a), the latter generates RRC Connection Reconfiguration carrying all the addition information and sends it to the UE (302). The UE (302) checks when all the configurations in the message are possible in the UE (302) and sends a RRC Connection Reconfiguration Complete message to the MN (102a).

After the MN (102a) receives the RRC Connection Reconfiguration Complete message from the UE (302), it informs the SN (102b) that the UE (302) has completed the reconfiguration procedure. These steps are done for transferring the NR SIB for initial configuration. The MSI (320) includes a NRMIB (322) and a NR SIB (324).

In the Random Access Procedure, the UE (302) detects a PSS (701), a SSS, and the PBCH (702) of the SN and performs the RACH procedure to the cell of the SN (102b). The UE (302) acquires all the information required for the RACH procedure from the RRC Connection Reconfiguration message instead of the SIB from the SN (102b).

The status of the SN (102b) is then transferred to the SN (102b) from the MN (102a), and data is forwarded between the MN (102a) and the S-GW (101c). The path update procedures include the steps from an Evolved Radio Access Bearer (E-RAB) Modification Indication to the E-RAB Modification Confirm.

In the E-RAB Modification Indication, the MN (102a) sends a message to the MME (101a) indicating that the S-GW (101c) has successfully forwarded the UE (302) data traffic. The MME (101a) then sends a Bearer Modification to the S-GW (101c), in-structing it to modify the E-RAB of the UE (302). Further, the MN (102a) sends an End Marker Packet to the SN (102b) indicating the end of the E-RAB modification process, and the E-RAB modification is confirmed.

FIG. 4A depicts a sequence diagram that illustrates a process of handling system information change in MR-DC, according to the prior art as disclosed herein. The required MSI (320) for both PSCell and SCells is provided by dedicated signaling through RRC Reconfiguration. The UE (302) acquires the MIB (704) of the cell, and the network releases and adds the connected cell when the MSI (320) of the cell changes, only when RRC Reconfiguration with Sync is implemented.

At step S1, the MN (102a) sends a SN Addition Request to the SN (102b), which includes the UE (302) capabilities and coordination results, the latest measurement result of the cell shared to the SN (102b) for selection, and security information. At step S2, the SN (102b) sends a SN Addition Request Acknowledge to the MN (102a), including radio resources configuration, additional information of the decided cell to share in the MSI (320), and radio resource configuration.

At step S3, when the SN (102b) accepts the SN Addition Request and shares the addition information in the MSI (320) to the MN (102a), the MN (102a) generates a RRC Connection Reconfiguration carrying the addition information and sends it to the UE (302). The network sends the Reconfig with synchronization (420) in the RRC Connection Reconfiguration by releasing the connected cell first and adding the connected cell after synchronization.

At step 4, the UE (302) initiates the Random Access Procedure to establish connection between the UE (302) and the MN (102a), and at step 5, after receiving the RRC Connection Reconfiguration, the UE (302) checks if all the configurations in the message are possible in the UE (302) and sends the RRC Connection Reconfiguration Complete message to the MN (102a).

At step 6, once the MN (102a) receives the RRC Connection Reconfiguration from the UE (302), the MN (102a) sends the RRC Connection Reconfiguration Complete message to the SN (102b), informing it that the UE (302) has completed the reconfiguration procedure. At step 7, in a Random Access Procedure, the UE (302) detects the PSS (701), the SSS, and the PBCH (702) of the SN and performs the RACH procedure to the cell of the SN (102b).

The status of the SN (102b) is transferred to the MN (102a) at step S8, and data is forwarded between the MN (102a) and S-GW (101c) after the SN (102b) status is transferred to the SN (102b). Further, at step 10, a secondary RAT data usage report is transferred from the SN (102b) to the MN (102a) for monitoring the data traffic and signaling on the Secondary RAT, including the amount of data transmitted and received, quality of the connection, and other performance indicators.

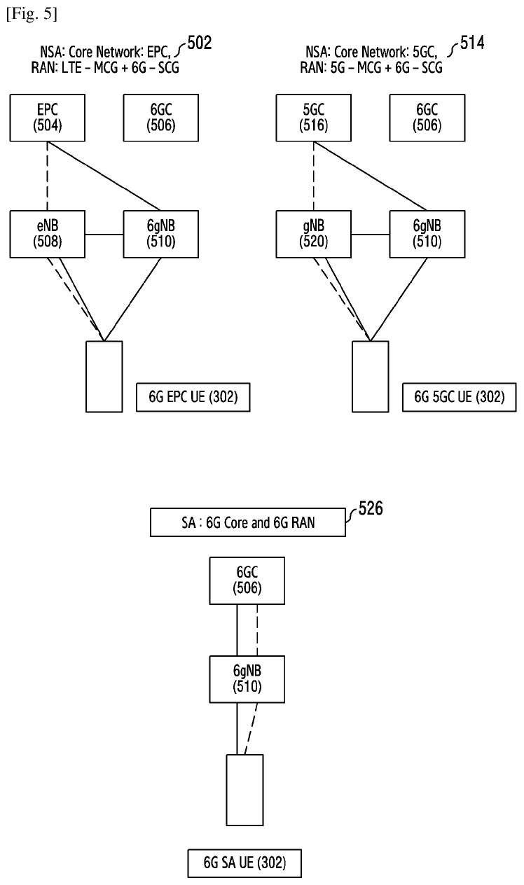

FIG. 5 is a block diagram that illustrates 6G Baseline Architecture option(s), according to the prior art as disclosed herein. Depending on the specific use cases, such as cost, complexity, and scalability, existing or new deployments are added to the LTE and 5G in the NSA to introduce the 6G RAT.

The 6G baseline architecture comprises the NSA (Non-Standalone)-Core Network EPC (502), NSA Core Network 5GC (514), SA 6G Core, and 6G RAN (Random Access Network) (526). In the NSA Core Network, the EPC (504) is utilized for handling data connectivity, mobility management, and other functions in a packet-switched network. The EPC (504) enables easy selection of the 6 gNB (510).

The RAN in the NSA Core Network EPC (502) includes a Master Cell Group (MCG) and a SCG (Secondary Cell Group) associated with the 6G network architecture options in NSA. The MCG is managed by the LTE RAN and includes a eNB (508), which is responsible for controlling and managing communication between the 6 gNB (510) and 6G EPC UE (302). The SCG includes additional capacity and capabilities, allowing the UE (302) to simultaneously connect to both the MCG (LTE) and 6G SCG for improved data rates and performance to share the MSI (320).

In the NSA Core Network with the 5GC (502), the RAN has included 5G MCG and 6G SCG, enabling enhanced data throughput, reliability, and seamless mobility by managing connections between different base stations. The 6G SCG in the NSA Core Network with the 5GC (514) provides additional resources and capabilities, con-tributing to enhanced data throughput, improved reliability, and better overall network performance. The 5GC (516) controls data control plane operations, delivers network services, and provides extra layers of security. Additionally, the 5GC (516) authenticates, controls, enforces policies, and manages the mobility of 5G devices. The 5G (gNB) (520) provides connectivity between 6G 5GC UE (302) and the 6 gNB (510).

The 6G network in the SA includes the 6GC and 6G RAN, with the 6GC (506) connected to the 6 gNB (510). The 6 gNB (510) improves agility, scalability, reduces latency, and increases bandwidth. It also stores more information compared to the existing LTE and 5G to share MSI (320) with additional information to the UE (302).

As shown in FIG. 5, defining the necessary modifications in the MSI (320) acquisition procedure, handling changes in the SI, and associated changes to the contents of the MSI (320) is due to the addition of 6G RAT to meet more stringent and refined KPIs (performance)/KVIs (values) and realize the 6G use-cases.

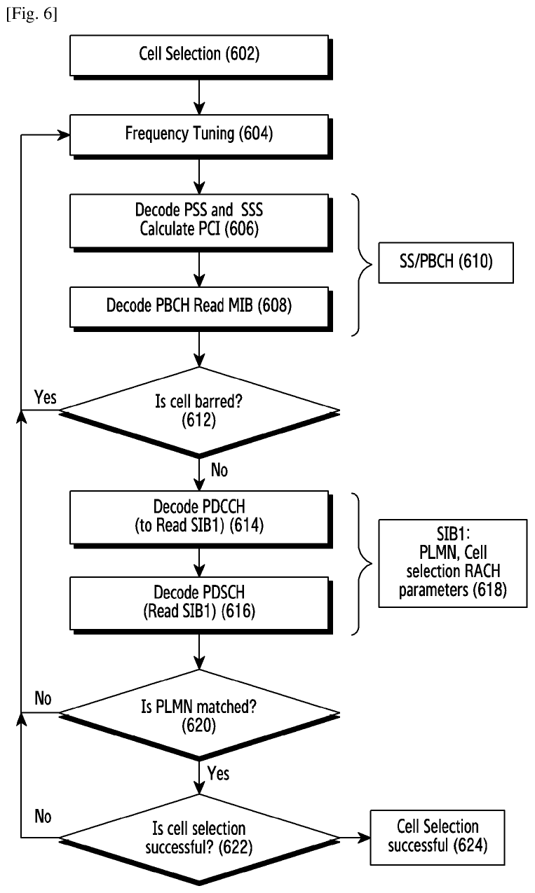

FIG. 6 is a flow chart that illustration the acquisition of minimal system information in SA within NR, according to the prior art as disclosed herein. At step 602, cell selection is based on the UE (302) tuned frequency, with the cell continuously broadcasting frequencies to synchronize with the UE (302). At step 604, the UE (302) tunes a frequency range to identify and select a suitable cell, scanning available frequencies to detect the cell in the broadcasting frequencies.

At step 606, the UE (302) searches for and decodes the PSS (701) and SSS (703) broadcasted by the cell, which are part of the SS. The PSS (701) and SSS (703) aid in cell search and identification, enabling the UE (302) to synchronize with the cell's timing and frame structure. The PSS (701) provides critical timing information and conveys details about a physical cell identity group, distinguishing between candidate cells during initial access and handover processes. The UE (302) calculates a Physical Cell Identifier (PCI) based on the information obtained from the PSS (701) and SSS (703), uniquely identifying a cell within the cell group.

At step 608, the UE (302) decodes the PBCH (702) to read the MSI (320), which includes the MIB (704). The MIB contains system bandwidth frame configuration and physical cell identity (PCI) information, enabling synchronization with the cell. Step 610 includes the SS (PSS (701) and SSS (703)) from step 606 and the PBCH (702) from step 608, with the PBCH broadcasting the MSI (320) to the UE (302) for decoding and reading to facilitate cell selection.

At step 612, the UE (302) determines if the cell is barred based on the decoded PSS and SSS, calculated PCI and MIB information. If the cell is not barred, the UE (302) continues to read the SIB. If the cell is barred, the UE (302) initiates the cell selection process by tuning the frequency to select a new cell.

At step 614, when the cell is not barred, the UE (302) reads the Physical Downlink Control Channel (PDCCH) delivers control information from the network apparatus (113) to the UE (302), including network apparatus (113) allocation, scheduling as-signments, and control commands. The UE (302) continuously monitors the PDCCH to decode and read the SIB1, which is part of the MSI (320) broadcasted by the network apparatus (113) through PDCCH to the UE (302). The SIB1 includes static information of the cell.

At step 616, based on the decoded PDCCH, the UE (302) knows the location and resources allocated to the PDSCH carrying the SIB1, which the UE (302) decodes to extract and read the SIB1. The UE (302) uses the SIB1 information to take further steps to select the cell.

At step 618, the SIB1 includes a PLMN, area code, cell identifier, at least one value TAG parameter, and a RACH parameter indicating a RACH configuration required for the UE (302) to perform a RACH. The SIB1 defines the scheduling of the SIB and comprises information required for initial access. The SIB1 is periodically broadcast on a Downlink Shared Channel (DL-SCH) (100g) or sent in a dedicated manner on the DL-SCH (100g) to the UE (302) in a RRC_CONNECTED.

Further, at step 620, the UE (302) determines cell selection based on whether the PLMN stored in the UE (302) matches the PLMN broadcasted by the cell. At step 622, the UE (302) checks if the cell selection was successful.

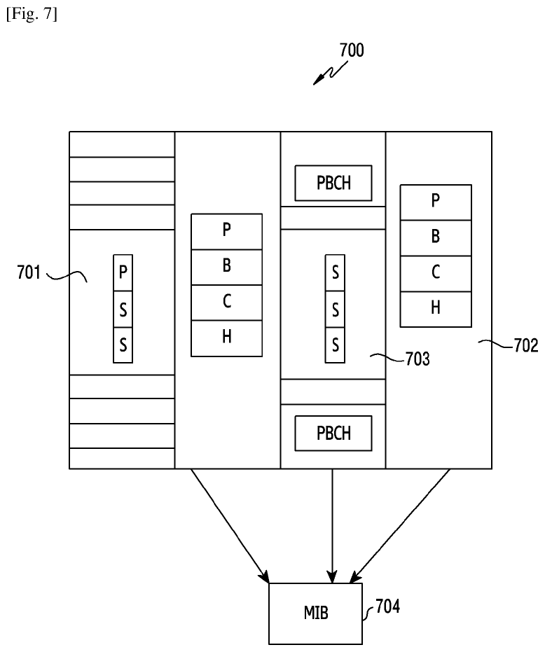

FIG. 7 is a block diagram that illustrates sharing of master information block in 5G, according to the prior art as disclosed herein. The 5G MSI (320) sharing encompasses the PSS (701), SSS (703), and PBCH (702). In 5G NR, PSS (701) and SSS (703) are integral parts of the SS. The UE (302) searches and decodes the PSS (701) and SSS (703) broadcasted by the cell, utilizing them for cell search and identification. The PBCH (702) carries the MIB (704) and shares it with the UE (302). MIB (704) contains cell barred status information and crucial physical layer details of the cell.

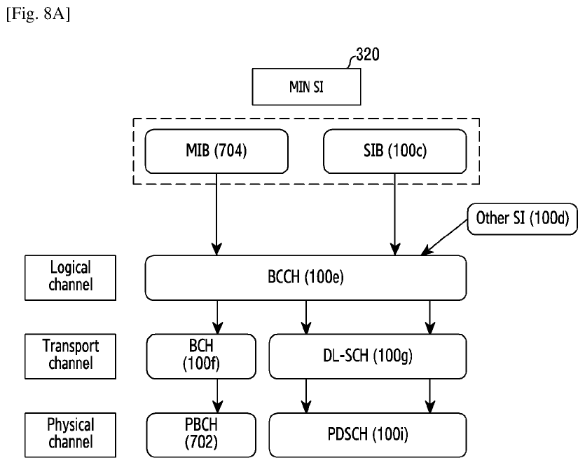

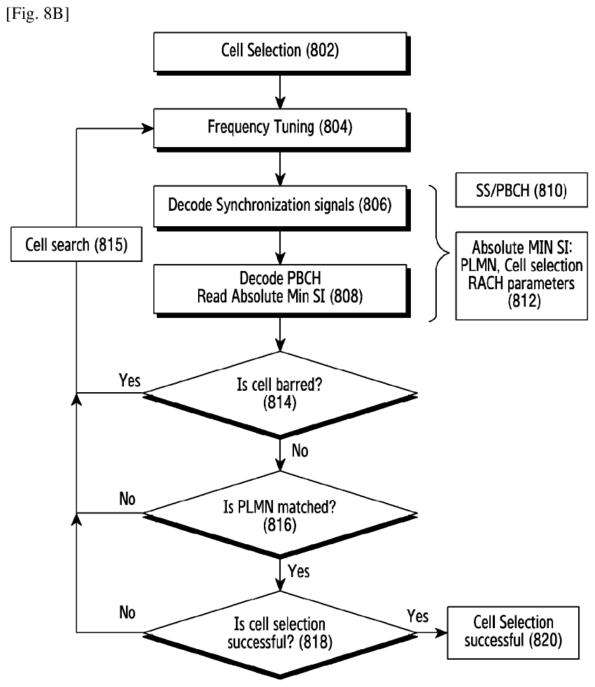

FIG. 8A is a block diagram that illustrates channel mapping of system information in the 5G, according to the prior art as disclosed herein. This mapping provides valuable insights into how data is transmitted through various channels. The MSI (320) comprises of two components, namely the MIB (704) and the SIB (100c), which are not combined and not shared through a single channel. The former is shared through the PBCH (702), while the latter is shared through a PDSCH (100i) to the UE (302).

The channel mapping consists of a logical channel, a transport channel, and a physical channel. The Broadcast Control Channel (BCCH) (100e) is part of the logical channel and receives the MSI (320) from the cell, along with other SI (100d). The BCCH (100e) then sends the MIB (704) to the Broadcast Channel (BCH) (100f), and the SIB (100c) to the DL-SCH (100g) in the transport channel.

Furthermore, the MIB (704) from a BCH is shared with the PBCH (702), while the SIB from the DL-SCH (100g) is shared with the PDSCH (100i). Further, the MSI (320), including the MIB (704) and SIB (100c), are shared with the UE (302) through different channels, namely the PBCH (702) and the PDSCH (100i).

FIG. 8B is a flow chart that illustrates acquisition of the minimum system information in SA in the 6G, according to the embodiment as disclosed herein. At step 802, the cell or a SN (113) is selected based on the UE (111) tuned frequency. In step 804, the UE (111) tunes a frequency to find and select a suitable cell based on the tuned frequency in 6G. The UE (111) scans available frequencies to detect the cell in the broadcasting frequencies.

In step 806, the UE (111) searches and decodes the PSS and the SSS broadcasted by the cell, which are part of the SS. The PSS and the SSS aid the UE (111) in the cell search and identification process, helping it synchronize with the cell timing and frame structure. The PSS provides critical timing information and conveys physical cell identity group details, assisting the UE (111) in distinguishing between candidate cells during initial access and handover processes. The UE (111) calculates the PCI based on the information obtained from the PSS and SSS, which uniquely identifies a cell within the cell group.

In step 808, the UE (111) decodes the PBCH to read the MSI (904A), which is the combined MIB and SIB The MSI (904A) includes system bandwidth frame configuration and PCI information, allowing the UE (111) to synchronize with the cell.

The PBCH broadcasts the MSI (904A) to the UE (111) to decode and read for cell selection. The SS, comprising the PSS and the SSS, is part of step 806, while the PBCH, including the MSI (904A), is part of step 808.

In step 812, the MSI (904A) includes a PLMN, an area code, a cell identifier, at least one value TAG parameter, and a RACH parameter indicating the RACH configuration required for the UE (111) to perform a RACH. Step 814 involves determining whether the cell is barred or not after decoding the PBCH using the MSI (904A). When the cell is not barred, the UE (111) continues to match one of the information in the MSI (904A) with the information available in the UE.

In step 816, the PLMN stored in the UE (111) is matched with the PLMN broadcasted by the cell, and the UE (111) determines the selection of the cell when the PLMN is matched. Further, in step 818, the UE (111) checks whether the cell selection was successful or not.

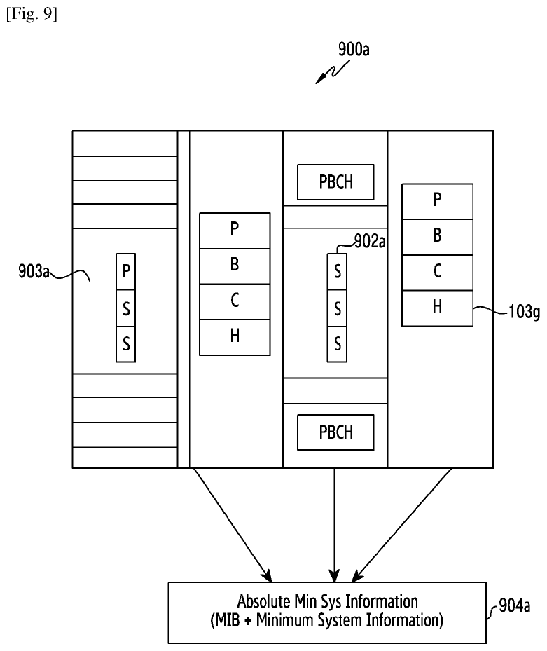

FIG. 9 is a block diagram that illustrates sharing of the minimum system information in the 6G through PBCH, according to the embodiment as disclosed herein. This process involves the transmission of the PSS (903a), the SSS (902a), and a PBCH (103g) as part of the 6G (900a) system. The PSS (903a) and SSS (902a) are components of the SS, which are searched and decoded by the UE (111) for cell identification. The PBCH (103g) carries the MSI (904A), which is combined with the MIB and shared with the UE (111) through the PBCH (103g) channel. Unlike 5G, the PBCH (103g) in 6G can accommodate more data packets, which can be shared with the UE (111) solely through this channel.

The necessity and usefulness of the Absolute MSI (904a) concept in 6G can be justified by several aspects. Firstly, 6G is expected to accommodate a greater number of data bits within a resource element compared to its predecessors, 4G/5G. This enables 6G to pack in more data in its absolute MSI (904a), thereby addressing the first query as to why it was not possible to implement in 4G/5G due to their restricted number of bits in lower radio access technologies.

Furthermore, in NR MIB, we observe that some of the original SIB contents were integrated into MIB, such as cell barred. In 6G, the extension of this concept is that the minimum required system information can be packed into a single channel, rather than being distributed over multiple channels, through the implementation of MSI (904a).

Regarding delay in synchronization, in both the LTE and the NR, the UE (111) is deemed camped on a cell once it has successfully decoded the PSS, the SSS for synchronization, read the MIB for the SIB access, and read the SIB to verify the PLMN barring cell selection criteria. This means that even today, the UE (111) must read the MIB and SIB to fully camp on a channel. To address this issue, the proposal is to leverage the 6G capacity for packing more bits and design the system information in a manner that allows for the absolute MSI (904a) required for cell camping to be sent together in a single channel. This approach would eliminate any additional delay that may arise from the acquisition of the SIB

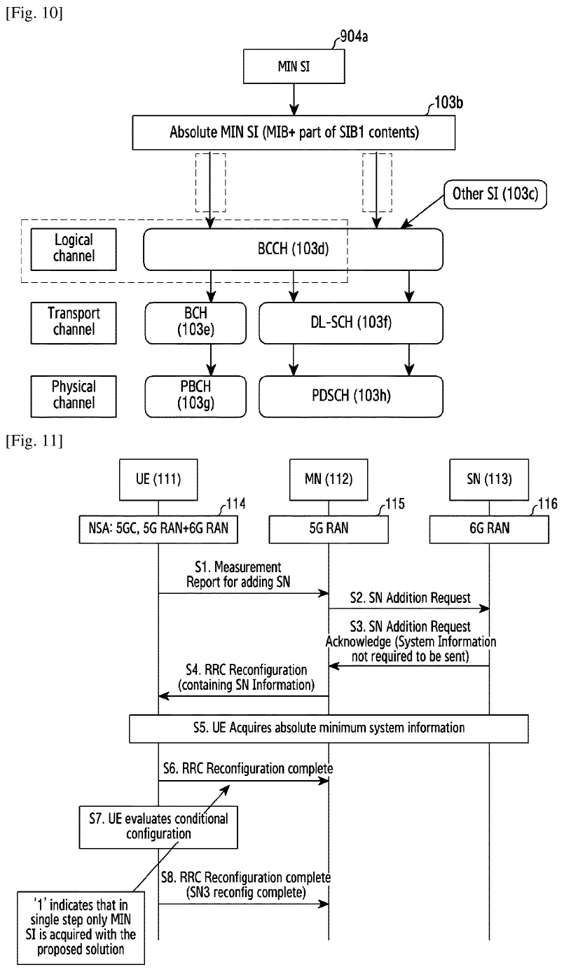

FIG. 10 is a block diagram that illustrates channel mapping of the system information in the 6G, according to the embodiment as disclosed herein. The channel mapping in 6G is designed to provide valuable insights into how data is transmitted through the channels. The MSI (904A) comprises both the MIB and the SIB, which are combined (103b) and shared through either the PBCH (103g) or the PDSCH (103b) to the UE (111).

The channel mapping comprises a logical channel, a transport channel, and a physical channel. The logical channel encompasses the BCCH (103d), which receives the MSI (904A) from the cell and other SI (100d). The BCCH (103d) in the logical channel transmits the MSI (904A) to the BCH (103e) and a DL-SCH (103f) in the transport channel.

Furthermore, the MSI (904A) obtained from the BCH (103e) is shared with the PBCH (103g), whereas the MSI (904A) obtained from the DL-SCH (103f) is shared with the PDSCH (103h). The MSI (904A) is further transmitted to the UE (111) through the PBCH (103g) and the PDSCH (103h).

FIG. 11 depicts a sequence diagram that illustrates a process of acquiring the minimum system information in the MR-DC, according to the embodiment as disclosed herein. In the current scenario the network apparatus (113) is the SN (113). The SN (113) broadcasts the MSI (904A) directly to the UE (111) without involving the MN (112). This eliminates the need for inter-node messaging between the SN (113) and the MN (112), thereby reducing its size. The UE (111) is an NSA 5GC 5G RAN+6G RAN (114), the MN (112) is a 5G RAN (115), and the SN (113) is a 6G RAN (116).

In step 1, the UE (111) forwards a measurement report to the MN (112) with 6G RAT information to add to the UE (111). In step 2, the MN (112) sends an SN Addition Request message to the SN (113) containing relevant measurement information. In step 3, the SN (113) responds with an SN Addition Request Acknowledge message without adding the MSI (904A) associated with the SN (113) since it is already shared by the SN (113). In step 4, the MN (112) sends the UE (111) an RRC reconfiguration that includes the SN (113) information. The MN (112) does not encapsulate the MSI (904A) from the SN (113), thus saving encoding the SIB information in the RRC reconfiguration to the UE (111).

In step 5, the UE (111) receives the MSI (904A) directly from the SN (113) to camp on and read the MSI (904A) without decoding since the MSI (904A) is not encoded while sharing. In step 6, the UE (111) sends an RRC Reconfiguration Complete message to the MN (112). In step 7, the UE (111) assesses conditional configuration. Further, in step 8, the UE (111) sends the RRC Reconfiguration Complete message to the MN (112).

FIG. 12 depicts a sequence diagram that illustrates the call flow for the system information change, according to the embodiment as disclosed herein. In the current scenario the network apparatus (113) is the SN (113). Notably, the SN (113) modification for the 6G RATs does not require a complete RRC reconfiguration with synchronization procedure in the event of a change in the MSI (904A). At step 1, the SN (113) sends a message to the MN (112) indicating the required modification in the MSI (904A). At steps S2 and S3, the SN (113) modification is executed. At step S4, the MN (112) sends a single bit indication RRC reconfiguration message to the UE (111) indicating the MSI (904A) modification. The UE (111) then reads and receives the MSI (904A) at step S5. Once the RRC reconfiguration is completed, the MN (112) sends a confirmation message to the SN (113) at step S7. At step S8, the UE (111), MN (112), and SN (113) engage in Random Access Procedures, followed by data forwarding procedures at step S9, involving the UE (111), MN (112), SN (113), UPF (117), and AMF (118).

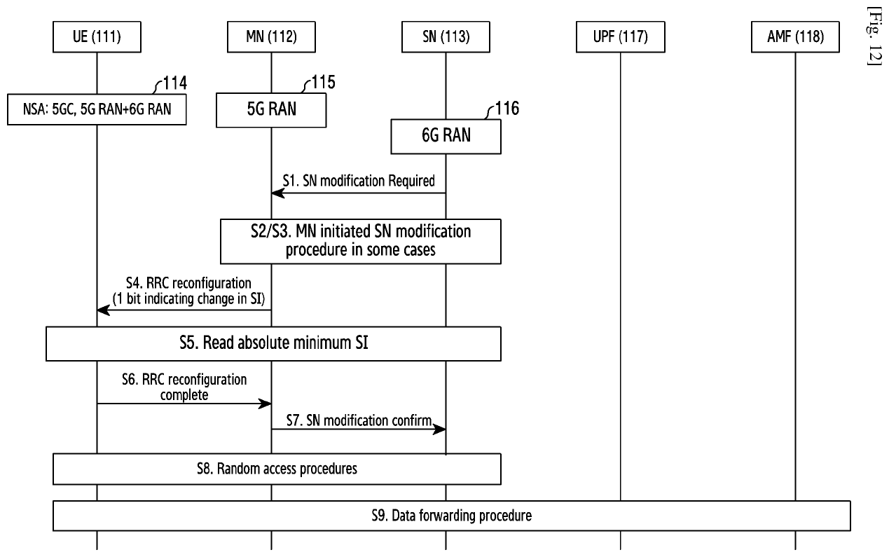

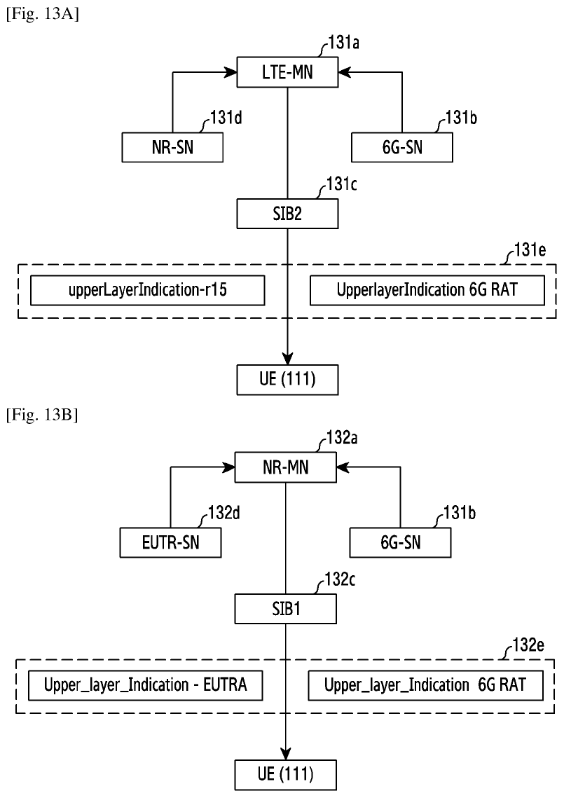

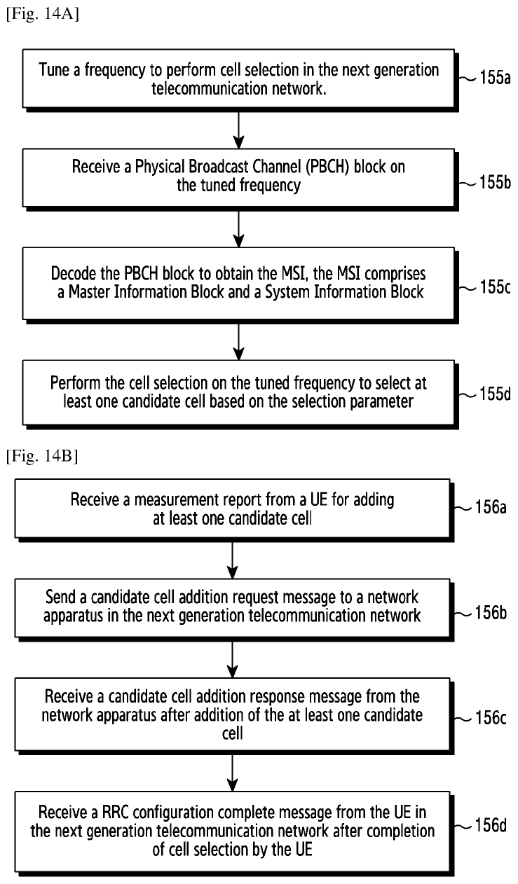

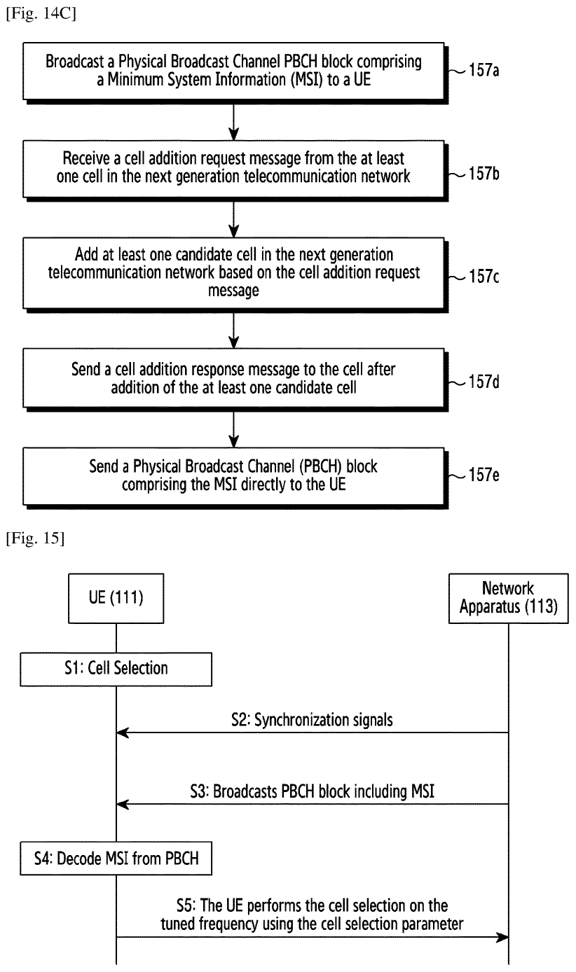

FIG. 13 illustrates secondary node information in the LTE for the 6G RAT, according to the embodiment as disclosed herein. In accordance with the embodiment, FIG. 14A depicts secondary node information in LTE for 6G RAT. Specifically, a NR-SN (131d) and a 6G-SN (131b) are connected to an LTE-MN (131a). The LTE-MN (131a) is responsible for transmitting a SIB2 to signify the incorporation of 6G RAT within the network. This SIB2 is comprised of the PLMN-Info-r15, which includes an upperLayerIndication-r15 ENUMERATED {true} to alert the UE (111) of the added 5G RAT as per prior art. In current embodiment it is proposed that the LTE-MN, SIB2 shall include another upper_layer_Indication with 6G RAT to indicate the presence of a 6G SN.

FIG. 13B illustrates secondary node information in 5G for the 6G RAT, according to the embodiment as disclosed herein. The embodiment disclosed herein is depicted in FIG. 14B, showcasing secondary node information in 5G for 6G RAT. A NR-MN (132a) is connected to both an EUTR-SN (132d) and a 6G-SN (131b). The NR-MN (132a) carries a SIB1, which serves to indicate the presence of the added 6G RAT in the network. This SIB1 includes an Upper_layer_Indication ENUMERATED {6G RAT EUTRA}, effectively communicating the existence of the 6G RAT to the UE (111).

FIG. 14A a flow diagram that illustrates a method for handling minimum system information by user equipment, according to the embodiment as disclosed herein.

At step 155a, the UE (111) tunes the frequency to perform cell selection in the next generation telecommunication network. The UE (111) tuned frequency selects the frequency of the cell and matches with the cell frequency to select the cell. The UE (111) reads the MSI (904a) of the cell.

At step 155b, the UE (111) receives the PBCH (103g) block on the tuned frequency. The PBCH (103g) block is broadcasted from the network apparatus (113). The PBCH (103g) block stores more data in the 6G compared to the NR. The more data ac-cumulates all required information in one channel and send through the single PBCH (103g) channel.

At step 155c, decode the PBCH (103g) block to obtain the MSI (904a), the MSI (904a) includes the MIB and the SIB. The network apparatus (113) continues to broadcast the PBCH (103g) block including the MSI (904a) to the UE (111).

At step 155d, perform the cell selection on the tuned frequency to select the at least one candidate cell. The cell selection is determined on the at least one of at least one cell selection parameter of the at least one candidate cell, the at least one cell access related parameter of the at least one candidate cell, the value tag indicating whether the MSI (904a) is valid or a change has occurred, and the at least one RACH parameter of the at least one candidate cell. at least one candidate cell is barred. When cell is not barred the selection happens successfully from the UE (111). When the cell is barred the selection process repeats from tuning the frequency of the UE (111) to select the cell.

FIG. 14B a flow diagram that illustrates a method for handling minimum system information by MN, according to the embodiment as disclosed herein. In this scenario the network apparatus (113) is referred as SN (113).

At step 156a, receive a measurement report from the UE (111) for adding at least one candidate cell. The measurement report includes the 6G RAT information. The 6G RAT information included a cell identity, a signal strength of the cell, a neighboring cell information, a neighbor cell identity, a signal-to-noise ratio, a bit error rate, and an area code.

At step 156b, send a candidate cell addition request message to a network apparatus (113) in the next generation telecommunication network. The candidate cell addition request message is sent from the MN (112) to the SN (113) with relevant measurement information. The SN (113) sends the updated information to the UE (111). Compared to the legacy system the SN (113) sends the addition request message without adding the MSI (904a) which is already shared by the SN (113) to the UE (111).

At step 156c, receive a candidate cell addition response message from the network apparatus (113) to the UE (111) after addition of the at least one candidate cell. The cell addition response message sent from the SN (113) is not included the MSI (904a) because the SN (113) is already shared the MSI (904a) to the UE (111) directly. The SN (113) directly shares the MSI (904a) without sending it to the MN (112). This reduces the size of inter node message between SN (113) and MN (112).

At step 156d, The MN (112) receives the RRC configuration complete message from the UE (111) after completion of cell selection by the UE (111). The MN (112) further sends the RRC reconfiguration including the SN (113) information to the UE (111).

The MN (112) does not encapsulate the MSI (904a) from the SN (113) compared to the legacy system. The proposed solution not needed to send the MSI (904a) to the UE (111) when compared to legacy. The proposed solution reduces the steps taken to receive the MSI (904a) from the SN (113) to the UE (111) and saves time on encoding the SIB information from the MN (112) in a RRC reconfiguration to the UE (111).

FIG. 14C a flow diagram that illustrates a method for handling minimum system information by network apparatus, according to the embodiment as disclosed herein.

At step 157a, the network apparatus (113) broadcasts the PBCH (103g) block including the MSI (904a) to the UE (111). The MSI (904a) in the PBCH (103g) block is included both the MIB and the system information. The PBCH (103g) block includes the MSI (904a) and shares it to the UE (111) instead of sharing the MIB and the MSI (904a) separately through the PDCCH and the PDSCH channels. At step 157b, the network apparatus (113) receives a cell addition request message from the at least one cell in the next generation telecommunication network. The cell addition request message includes the 6G RAT information including 6G RAT frequency, and cell selection parameters.

At step 157c, the network apparatus (113) adds at least one candidate cell based on the cell addition request message. The cell addition request message is sent by the UE (111) to the network apparatus (113) to add 6G cells to the set of the cell. The cell is added with the MSI (904a) of the added cell information.

At step 157d, once the cell is added to the cell network based on the cell addition request message. The cell addition response message is sent to the network apparatus (113) that new cells are added in the cell group. The new cells carrying the MSI (904a) which provides information of the added cells.

At step 157e, the PBCH (103g) block including the MSI (904a) is sent directly to the UE (111). The PBCH (103g) included the MSI (904a) comprises MIB and the SIB. The SIB includes parameters which are used to select the cell. The cell selection parameters are the cell access related parameter, the value tag including the MSI, the updated MSI indicating parameter, and at least one RACH parameter. The value tag indicates the valid SI and change in the SI. The RACH parameters includes the necessary the RACH config parameters required for the UE (111) to perform a RACH configuration. The cell access related parameters includes the cell access related Info like the PLMN, the area code, cell ID etc.

FIG. 15 depicts a sequence diagram that illustrates the system information sharing in the SA, according to the embodiment as disclosed herein. At step S1, the UE (111) tunes its frequency for cell selection on the frequency transmitted by the network apparatus (113)

At step S2, the UE (111) synchronizes with the network apparatus (113) using the primary and secondary synchronization signals.

At step S3, the UE (111) receives the broadcasted PBCH (103g) block from the network apparatus (113) on the tuned frequency. The PBCH (103g) included the MSI (904a) of the selected cell. The MSI (904a) is used for the synchronization and initial configuration of the UE (111) with the selected cell.

At step S4, the UE (111) decodes the PBCH (103g) block to acquire the MSI (904a). The MSI (904a) includes both the MIB and the SIB. The SIB includes at least one of the cell selection parameter, the cell access-related parameter, the value tag indicating the validity of the MSI or any changes, and at least one Random Access Channel (RACH) parameter.

At step S5, the UE (111) performs the cell selection on the tuned frequency to select at least one candidate cell based on the at least one cell selection parameter, at least one cell access related parameter, the value tag and the at least one RACH parameter. The UE (111) sends the cell selected information to the network apparatus (113).

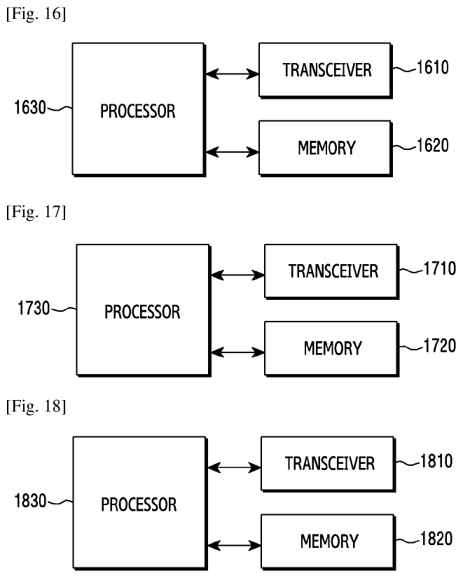

FIG. 16 is a structure of a user equipment according to the embodiments.

As shown in FIG. 16, the UE according to an embodiment may include a transceiver 1610, a memory 1620, and a processor 1630. The transceiver 1610, the memory 1620, and the processor 1630 of the UE may operate according to a communication method of the UE described above. However, the components of the UE are not limited thereto. For example, the UE may include more or fewer components than those described above. In addition, the processor 1630, the transceiver 1610, and the memory 1620 may be implemented as a single chip. Also, the processor 1630 may include at least one processor. Furthermore, the UE of FIG. 16 corresponds to the UE of the FIG. 3A.

The transceiver 1610 collectively refers to a UE receiver and a UE transmitter, and may transmit/receive a signal to/from a base station or a network entity. The signal transmitted or received to or from the base station or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the UE. Also, the memory 1620 may store control information or data included in a signal obtained by the UE. The memory 1620 may be a storage medium, such as read-only memory (ROM), random access memory (RAM), a hard disk, a CD-ROM, and a DVD, or a combination of storage media.

The processor 1630 may control a series of processes such that the UE operates as described above. For example, the transceiver 1610 may receive a data signal including a control signal transmitted by the base station or the network entity, and the processor 1630 may determine a result of receiving the control signal and the data signal transmitted by the base station or the network entity.

FIG. 17 is a structure of a base station according to the embodiments.

As shown in FIG. 17, the base station according to an embodiment may include a transceiver 1710, a memory 1720, and a processor 1730. The transceiver 1710, the memory 1720, and the processor 1730 of the base station may operate according to a communication method of the base station described above. However, the components of the base station are not limited thereto. For example, the base station may include more or fewer components than those described above. In addition, the processor 1730, the transceiver 1710, and the memory 1720 may be implemented as a single chip. Also, the processor 1730 may include at least one processor. Furthermore, the base station of FIG. 17 corresponds to the base station of the FIG. 3C.

The transceiver 1710 collectively refers to a base station receiver and a base station transmitter, and may transmit/receive a signal to/from a terminal(UE) or a network entity. The signal transmitted or received to or from the terminal or a network entity may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor 1730, a signal through a wireless channel, and transmit a signal output from the processor 1730 through the wireless channel.

The memory 1720 may store a program and data required for operations of the base station. Also, the memory 1720 may store control information or data included in a signal obtained by the base station. The memory 1720 may be a storage medium, such as read-only memory (ROM), random access memory (RAM), a hard disk, a CD-ROM, and a DVD, or a combination of storage media.

The processor 1730 may control a series of processes such that the base station operates as described above. For example, the transceiver 1710 may receive a data signal including a control signal transmitted by the terminal, and the processor 1730 may determine a result of receiving the control signal and the data signal transmitted by the terminal.

FIG. 18 is a structure of a network entity according to the embodiments.

Referring to FIG. 18, the network entity includes a transceiver (1810), a memory (1820), and a processor (1830). The transceiver (1810), the memory (1820), and the processor (1830) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (1830), the transceiver (1810), and the memory (1820) may be implemented as a single chip. Also, the processor (1830) may include at least one processor. Furthermore, the network entity of FIG. 18 corresponds to the network apparatus of the FIG. 3B.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (1810) collectively refers to a network entity receiver and a network entity transmitter, and may transmit/receive a signal to/from a base station or a UE. The signal transmitted or received to or from the base station or the UE may include control information and data. In this regard, the transceiver (1810) may include an RF transmitter for up-converting and amplifying a frequency of a transmitted signal, and an RF receiver for amplifying low-noise and down-converting a frequency of a received signal. However, this is only an example of the transceiver (1810) and components of the transceiver (1810) are not limited to the RF transmitter and the RF receiver.

The transceiver (1810) may receive and output, to the processor (1830), a signal through a wireless channel, and transmit a signal output from the processor (1830) through the wireless channel.

The memory (1820) may store a program and data required for operations of the network entity. Also, the memory (1820) may store control information or data included in a signal obtained by the network entity. The memory (1820) may be a storage medium, such as a ROM, a RAM, a hard disk, a CD-ROM, and a DVD, or a combination of storage media.

The processor (1830) may control a series of processes such that the network entity operates as described above. For example, the transceiver (1810) may receive a data signal including a control signal, and the processor (1830) may determine a result of receiving the data signal.

In various embodiments, a method for handling minimum system information (MSI) in a wireless communication system, comprising: tuning, by a User Equipment (UE) (111), a frequency to perform cell selection in a next generation telecommunication network; receiving, by the UE (111), a Physical Broadcast Channel (PBCH) (103g) block on the tuned frequency, wherein the PBCH (103g) block is broadcasted from a network apparatus (113) in the next generation telecommunication network; decoding, by the UE (111), the PBCH (103g) block to obtain the MSI (904a), wherein the MSI (904a) comprises a Master Information Block (MIB) and a System Information Block (SIB), wherein the SIB comprises at least one of at least one cell selection parameter, at least one cell access related parameter, a value tag indicating whether the MSI is valid or a change has occurred, and at least one RACH parameter; performing, by the UE (111), the cell selection on the tuned frequency to select at least one candidate cell based on the at least one cell selection parameter, at least one cell access related parameter, the value tag and the at least one RACH parameter.

In various embodiments, performing, by the UE (111), the cell selection on the tuned frequency to select the at least one candidate cell comprises: determining, by the UE (111), whether the at least one candidate cell is barred based on the at least one cell selection parameter, the at least one cell access related parameter, the value tag, and the at least one RACH parameter; and performing, by the UE (111), one of: retuning the frequency to perform the cell selection, when the at least one candidate cell is barred, and performing the cell selection on the retuned frequency to select the at least one candidate cell, when the cell is not barred.

In various embodiments, performing the cell selection is on the tuned frequency to select the at least one candidate cell comprises: detecting, by the UE (111), the candidate cell based on the at least one cell access related parameter, the at least one cell selection parameter, the value tag, and the at least one RACH parameter; and performing, by the UE (111), one of: retuning the frequency to perform the cell selection, when the candidate cell is not detected, and selecting the at least one candidate cell, when the at least one candidate cell corresponding to the cell is detected.

In various embodiments, selecting the at least one candidate cell comprises: determining, by the UE (111), whether a cell selection criteria is met based on the at least one cell access related parameter, the at least one cell selection parameter, the tag value, and the at least one RACH parameter; and performing, by the UE (111), one of: retuning the frequency to perform the cell selection, when the cell selection criteria is not met, and selecting the at least one candidate cell and camping the UE (111) on the at least one selected candidate cell, when the cell selection criteria is met.

In various embodiments, decoding the PBCH (103g) block to obtain the MSI (904a) comprises: determining, by the UE (111), a Physical Channel Identifier (PCI) of a cell based on the decoded SS; and decoding, by the UE (111), the PBCH (103g) block to obtain the MSI (904a) based on the PCI of the cell.

In various embodiments, the at least one cell selection related parameter indicates cell selection threshold values required for the UE (111) to check whether the UE (111) meets the minimum cell selection criteria, wherein the at least one cell access related parameter indicates access information of the at least one of a PLMN, an area code, and a cell identifier, and wherein the at least one value TAG parameter comprises a value tag indicating whether a MSI is valid or a change has occurred, and the RACH parameter indicating a RACH configuration required for the UE (111) to perform a RACH.

In various embodiments, the RRC configuration request message comprises information of the at least one candidate cell added into the next generation telecommunication network by the network apparatus (113).

In various embodiments, the method further comprises: receiving, by the UE (111), a Radio Resource Control (RRC) configuration request message for the cell selection from a Master Node (MN) (112), wherein the MN (112) is connected to the network apparatus (113) when the UE (111) comprises a dual connectivity capability; receiving, by the UE (111), the MSI (904a) on the PBCH (103g) broadcast by the secondary node of the next generation telecommunication network; and sending, by the UE (111), a RRC configuration complete message to the MN (112) in the network after the cell selection.

In various embodiments, the next generation telecommunication network is a 6G telecommunication network and an advanced telecommunication network.

In various embodiments, a method for handling minimum system information MSI (904a) in a wireless communication system, comprising: receiving, by a MN (112), a measurement report from a UE (111) for adding at least one candidate cell in a next generation telecommunication network; sending, by the MN (112), a candidate cell addition request message to a network apparatus (113) in the next generation telecommunication network; receiving, by the MN (112), a candidate cell addition response message from the network apparatus (113) after addition of the at least one candidate cell in the next generation telecommunication network, while the network apparatus (113) continues to broadcast the PBCH (103g) block combining the MSI (904a) to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell; sending, by the MN (112), a Radio Resource Control (RRC) configuration request message to the UE (111), wherein the RRC configuration request message comprises the information of the candidate cell added into the next generation telecommunication network; and receiving, by the MN (112), a RRC configuration complete message from the UE (111) in the next generation telecommunication network after completion of cell selection by the UE (111).

In various embodiments, the cell addition response message comprises information of the candidate cell added into the next generation telecommunication network, and wherein the cell addition response message does not comprise System Information Block (SIB) as the MSI (904a) is already broadcasted by the network apparatus (113).

In various embodiments, the method comprises: receiving, by the MN (112), a cell modification request message from the cell to modify the at least one candidate cell; Initiating, by the MN (112), a cell modification procedure corresponding to the at least one candidate cell based on the cell modification request message; sending, by the network apparatus (113), a RRC reconfiguration message for the cell reselection after the cell modification, wherein the RRC reconfiguration message comprises one bit information indicating a change in system information corresponding to the at least one candidate cell, wherein the change in the system information indicates availability of the MSI (904a) on a PBCH (103g) block to enable the UE (111) to directly read the MSI (904a); receiving, by the network apparatus (113), a RRC reconfiguration complete message from the UE (111); and sending, by the network apparatus (113), a cell modification response message to the cell.

In various embodiments, a method for handling minimum system information (MSI) (904a) in a wireless communication system, comprising: broadcasting, by a network apparatus (113), a Physical Broadcast Channel PBCH (103g) block comprising a Minimum System Information (MSI) (904a) to a UE (111) in a next generation telecommunication network; receiving, by the network apparatus (113), a cell addition request message from the at least one cell in the next generation telecommunication network; adding, by the network apparatus (113), at least one candidate cell in the next generation telecommunication network based on the cell addition request message; and sending, by the network apparatus (113), a cell addition response message to the cell after addition of the at least one candidate cell in the next generation telecommunication network; and sending, by the network apparatus (113), a Physical Broadcast Channel (PBCH) (103g) block comprising the MSI (904a) directly to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell.

In various embodiments, the cell addition response message comprises information of the candidate cell added into the next generation telecommunication network, and wherein the cell addition response message does not comprise the SIB as the MSI (904a) is already broadcasted by the cell.

In various embodiments, the method further comprises: sending, by the network apparatus (113), the cell modification request message to the network apparatus (113) to modify the at least one candidate cell; imitating, by the network apparatus (113), a cell modification procedure corresponding to the at least one candidate cell based on the cell modification request message; and receiving, by the network apparatus (113), a cell modification response message from the at least one of the cell.

In various embodiments, the method further comprises: generating, by the network apparatus (113), a SIB message comprising a next generation RAT information for IRAT cell reselection with next generation frequencies and next generation neighbouring cell information; and sending, by the network apparatus (113), the SIB message to at least one neighbour cell of the network apparatus (113) in the next generation telecommunication network.

In various embodiments, the next generation RAT information is a 6G RAT information, wherein the next generation frequencies is 6G frequencies, and wherein next the generation neighbouring cell information is 6G neighbouring cell information, and wherein the at least one neighbour cell is one of 3G cell, 4G cell, and 5G cell.

In various embodiments, a UE (111) for handling system information in wireless communication system, comprising: a memory (205); a processor (203); and a system information controller (209), communicable coupled to the memory (205) and the processor (203), configured to: tune a frequency to perform cell selection in a next generation telecommunication network; receive a Physical Broadcast Channel (PBCH) block on the tuned frequency, wherein the PBCH (103g) block is broadcasted from a network apparatus (113) in the next generation telecommunication network; decode the PBCH (103g) block to obtain the MSI (904a), wherein the MSI (904a) comprises a Master Information Block (MIB) and a System Information Block (SIB), wherein the SIB comprises at least one of at least one cell selection parameter, at least one cell access related parameter, a value tag indicating whether the MSI is valid or a change has occurred, and at least one RACH parameter; perform the cell selection on the tuned frequency to select at least one candidate cell based on the at least one cell selection parameter, at least one cell access related parameter, the value tag and the at least one RACH parameter.

In various embodiments, performing the cell selection on the tuned frequency to select the at least one candidate cell comprises: determine whether the at least one candidate cell is barred based on the at least one cell selection parameter, the at least one cell access related parameter, the value tag, and the at least one RACH parameter; and perform one of: return the frequency to perform the cell selection, when the at least one candidate cell is barred, and perform the cell selection on the retuned frequency to select the at least one candidate cell, when the cell is not barred.

In various embodiments, performing the cell selection is on the tuned frequency to select the at least one candidate cell comprises: detect the candidate cell based on the at least one cell access related parameter, the at least one cell selection parameter, the value tag, and the at least one RACH parameter; and perform one of: retune the frequency to perform the cell selection, when the candidate cell is not detected, and select the at least one candidate cell, when the at least one candidate cell corresponding to the cell is detected.

In various embodiments, selecting the at least one candidate cell comprises: determine whether a cell selection criteria is met based on the at least one cell access related parameter, the at least one cell selection parameter, the tag value, and the at least one RACH parameter; and perform one of: retune the frequency to perform the cell selection, when the cell selection criteria is not met, and select the at least one candidate cell and camping the UE (111) on the at least one selected candidate cell, when the cell selection criteria is met.

In various embodiments, decoding the PBCH (103g) block to obtain the MSI (904a) comprises: determine a Physical Channel Identifier (PCI) of a cell based on the decoded SS; and decode the PBCH (103g) block to obtain the MSI (904a) based on the PCI of the cell.

In various embodiments, the at least one cell selection related parameter indicates cell selection threshold values required for the UE (111) to check whether the UE (111) meets the minimum cell selection criteria, wherein the at least one cell access related parameter indicates access information of the at least one of a PLMN, an area code, and a cell identifier, and wherein the at least one value TAG parameter comprises a value tag indicating whether a MSI is valid or a change has occurred, and the RACH parameter indicating a RACH configuration required for the UE (111) to perform a RACH.

In various embodiments, the RRC configuration request message comprises information of the at least one candidate cell added into the next generation telecommunication network by the network apparatus (113).

In various embodiments, 25. the system information controller further configured to: receive a Radio Resource Control (RRC) configuration request message for the cell selection from a MN (112) in the network, wherein the MN (112) is connected to the network apparatus (113) when the UE (111) comprises a dual connectivity capability; receive the MSI (904a) on the PBCH (103g) broadcast by the secondary node of the next generation telecommunication network; and send a RRC configuration complete message to the MN (112) in the network after the cell selection.

In various embodiments, the next generation telecommunication network is a 6G telecommunication network and an advanced telecommunication network.

In various embodiments, a network apparatus (113) for handling system information in a wireless communication system, comprising: a memory (215); a processor (211); and a system information controller (217), communicable coupled to the memory (215) and the processor (211), configured to: broadcast a Physical Broadcast Channel (PBCH) (103g) block comprising a Minimum System Information MSI (904a) to a UE (111) in the next generation telecommunication network; receive a cell addition request message from the at least one cell in the next generation telecommunication network; add by the network apparatus (113), at least one candidate cell in the next generation telecommunication network based on the cell addition request message; and send a cell addition response message to the cell after addition of the at least one candidate cell in the next generation telecommunication network; and send a Physical Broadcast Channel (PBCH) (103g) block comprising the MSI (904a) directly to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell.

In various embodiments, the cell addition response message comprises information of the candidate cell added into the next generation telecommunication network, and wherein the cell addition response message does not comprise the SIB as the MSI (904a) is already broadcasted by the cell.

In various embodiments, the system information controller further configured to: send the cell modification request message to the network apparatus (113) to modify the at least one candidate cell; imitate a cell modification procedure corresponding to the at least one candidate cell based on the cell modification request message; and receive a cell modification response message from the at least one of the cell.

In various embodiments, the system information controller further configured to: generate a SIB message comprising a next generation RAT information for IRAT cell reselection with next generation frequencies and next generation neighbouring cell information; and send the SIB message to at least one neighbour cell of the network apparatus (113) in the next generation telecommunication network.

In various embodiments, the next generation RAT information is a 6G RAT information, wherein the next generation frequencies is 6G frequencies, and wherein next the generation neighbouring cell information is 6G neighbouring cell information, and wherein the at least one neighbour cell is one of 3G cell, 4G cell, and 5G cell.

In various embodiments, a Master Node (MN) (112) for handling system information in a wireless communication system, comprising: a memory (304); a processor (301); and a system information controller (306), communicable coupled to the memory (304) and the processor (301), configured to: receive a measurement report from a UE (111) for adding at least one candidate cell in the next generation telecommunication network; send a candidate cell addition request message to a network apparatus (113) in the next generation telecommunication network; receive a candidate cell addition response message from the network apparatus (113) after addition of the at least one candidate cell in the next generation telecommunication network, while the network apparatus (113) continues to broadcast the PBCH (103g) block combining the MSI (904a) to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell; send a Radio Resource Control (RRC) configuration request message to the UE (111), wherein the RRC configuration request message comprises the information of the candidate cell added into the next generation telecommunication network; and receive a RRC configuration complete message from the UE (111) in the next generation telecommunication network after completion of cell selection by the UE (111).

In various embodiments, the cell addition response message comprises information of the candidate cell added into the next generation telecommunication network, and wherein the cell addition response message does not comprises System Information Block (SIB) as the MSI (904a) is already broadcasted by the network apparatus (113).

In various embodiments, the system information controller further configured to: receive a cell modification request message from the cell to modify the at least one candidate cell; initiate a cell modification procedure corresponding to the at least one candidate cell based on the cell modification request message; send a RRC reconfiguration message for the cell reselection after the cell modification, wherein the RRC reconfiguration message comprises one bit information indicating a change in system information corresponding to the at least one candidate cell, wherein the change in the system information indicates availability of the MSI (904a) on a PBCH (103g) block to enable the UE (111) to directly read the MSI (904a); receive a RRC reconfiguration complete message from the UE (111); and send a cell modification response message to the cell.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a user equipment (UE) for handling minimum system information (MSI) in a wireless communication system, comprising:
tuning a frequency to perform cell selection in a next generation telecommunication network;
receiving a Physical Broadcast Channel (PBCH) (103g) block on the tuned frequency, wherein the PBCH (103g) block is broadcasted from a network apparatus (113) in the next generation telecommunication network;
decoding the PBCH (103g) block to obtain the MSI (904a), wherein the MSI (904a) comprises a Master Information Block (MIB) and a System Information Block (SIB), wherein the SIB comprises at least one of at least one cell selection parameter, at least one cell access related parameter, a value tag indicating whether the MSI is valid or a change has occurred, and at least one RACH parameter;
performing the cell selection on the tuned frequency to select at least one candidate cell based on the at least one cell selection parameter, at least one cell access related parameter, the value tag and the at least one RACH parameter.

2. The method as claimed in claim 1, wherein performing the cell selection on the tuned frequency to select the at least one candidate cell comprises:
determining whether the at least one candidate cell is barred based on the at least one cell selection parameter, the at least one cell access related parameter, the value tag, and the at least one RACH parameter; and
performing one of:
retuning the frequency to perform the cell selection, when the at least one candidate cell is barred, and
performing the cell selection on the retuned frequency to select the at least one candidate cell, when the cell is not barred.

3. The method as claimed in claim 1, wherein decoding the PBCH (103g) block to obtain the MSI (904a) comprises:
determining a Physical Channel Identifier (PCI) of a cell based on the decoded SS; and
decoding the PBCH (103g) block to obtain the MSI (904a) based on the PCI of the cell.

4. The method as claimed in claim 1, wherein the at least one cell selection related parameter indicates cell selection threshold values required for the UE (111) to check whether the UE (111) meets the minimum cell selection criteria, wherein the at least one cell access related parameter indicates access information of the at least one of a PLMN, an area code, and a cell identifier, and wherein the at least one value TAG parameter comprises a value tag indicating whether a MSI is valid or a change has occurred, and the RACH parameter indicating a RACH configuration required for the UE (111) to perform a RACH.

5. The method as claimed in claim 1, wherein the method comprises:
receiving, by the UE (111), a Radio Resource Control (RRC) configuration request message for the cell selection from a Master Node (MN) (112), wherein the MN (112) is connected to the network apparatus (113) when the UE (111) comprises a dual connectivity capability; and
receiving, by the UE (111), the MSI (904a) on the PBCH (103g) broadcast by the secondary node of the next generation telecommunication network.
sending, by the UE (111), a RRC configuration complete message to the MN (112) in the network after the cell selection.

6. A method performed by a master node (MN) for handling minimum system information MSI (904a) in a wireless communication system, comprising:
receiving a measurement report from a UE (111) for adding at least one candidate cell in a next generation telecommunication network;
sending a candidate cell addition request message to a network apparatus (113) in the next generation telecommunication network;
receiving a candidate cell addition response message from the network apparatus (113) after addition of the at least one candidate cell in the next generation telecommunication network, while the network apparatus (113) continues to broadcast the PBCH (103g) block combining the MSI (904a) to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell;
sending a Radio Resource Control (RRC) configuration request message to the UE (111), wherein the RRC configuration request message comprises the information of the candidate cell added into the next generation telecommunication network; and
receiving a RRC configuration complete message from the UE (111) in the next generation telecommunication network after completion of cell selection by the UE (111).

7. The method as claimed in claim 6, wherein the cell addition response message comprises information of the candidate cell added into the next generation telecommunication network, and wherein the cell addition response message does not comprise System Information Block (SIB) as the MSI (904a) is already broadcasted by the network apparatus (113).

8. The method as claimed in claim 6, wherein the method comprises:
receiving a cell modification request message from the cell to modify the at least one candidate cell; and
Initiating a cell modification procedure corresponding to the at least one candidate cell based on the cell modification request message.

9. A UE (111) for handling system information in a wireless communication system, comprising:
a memory (205);
a processor (203); and
a system information controller (209), communicable coupled to the memory (205) and the processor (203), configured to:
tune a frequency to perform cell selection in a next generation telecommunication network;
receive a Physical Broadcast Channel (PBCH) block on the tuned frequency, wherein the PBCH (103g) block is broadcasted from a network apparatus (113) in the next generation telecommunication network;
decode the PBCH (103g) block to obtain the MSI (904a), wherein the MSI (904a) comprises a Master Information Block (MIB) and a System Information Block (SIB), wherein the SIB comprises at least one of at least one cell selection parameter, at least one cell access related parameter, a value tag indicating whether the MSI is valid or a change has occurred, and at least one RACH parameter;
perform the cell selection on the tuned frequency to select at least one candidate cell based on the at least one cell selection parameter, at least one cell access related parameter, the value tag and the at least one RACH parameter.

10. The UE (111) as claimed in claim 9, wherein performing the cell selection on the tuned frequency to select the at least one candidate cell comprises:
determining whether the at least one candidate cell is barred based on the at least one cell selection parameter, the at least one cell access related parameter, the value tag, and the at least one RACH parameter; and
performing one of:
returning the frequency to perform the cell selection, when the at least one candidate cell is barred, and
performing the cell selection on the retuned frequency to select the at least one candidate cell, when the cell is not barred.

11. The UE (111) as claimed in claim 9, wherein decoding the PBCH (103g) block to obtain the MSI (904a) comprises:
determining a Physical Channel Identifier (PCI) of a cell based on the decoded SS; and
decoding the PBCH (103g) block to obtain the MSI (904a) based on the PCI of the cell.

12. The UE (111) as claimed in claim 9, wherein the at least one cell selection related parameter indicates cell selection threshold values required for the UE (111) to check whether the UE (111) meets the minimum cell selection criteria, wherein the at least one cell access related parameter indicates access information of the at least one of a PLMN, an area code, and a cell identifier, and wherein the at least one value TAG parameter comprises a value tag indicating whether a MSI is valid or a change has occurred, and the RACH parameter indicating a RACH configuration required for the UE (111) to perform a RACH.

13. The UE (111) as claimed in claim 9, wherein the system information controller further configured to: receive a Radio Resource Control (RRC) configuration request message for the cell selection from a MN (112) in the network, wherein the MN (112) is connected to the network apparatus (113) when the UE (111) comprises a dual connectivity capability; and
receive the MSI (904a) on the PBCH (103g) broadcast by the secondary node of the next generation telecommunication network. send a RRC configuration complete message to the MN (112) in the network after the cell selection.

14. A Master Node (MN) (112) for handling system information in a wireless communication system, comprising:
a memory (304);
a processor (301); and
a system information controller (306), communicable coupled to the memory (304) and the processor (301), configured to:
receive a measurement report from a UE (111) for adding at least one candidate cell in a next generation telecommunication network;
send a candidate cell addition request message to a network apparatus (113) in the next generation telecommunication network;
receive a candidate cell addition response message from the network apparatus (113) after addition of the at least one candidate cell in the next generation telecommunication network, while the network apparatus (113) continues to broadcast the PBCH (103g) block combining the MSI (904a) to the UE (111), wherein the MSI (904a) comprises a Master Information Block (MIB) and a System Information Block (SIB), wherein the SIB comprises at least one of at least one cell selection parameter of the at least one candidate cell, at least one cell access related parameter of the at least one candidate cell, a value tag indicating whether the MSI is valid or a change has occurred, and at least one RACH parameter of the at least one candidate cell;
send a Radio Resource Control (RRC) configuration request message to the UE (111), wherein the RRC configuration request message comprises the information of the candidate cell added into the next generation telecommunication network; and
receive a RRC configuration complete message from the UE (111) in the next generation telecommunication network after completion of cell selection by the UE (111).

15. The MN (112) as claimed in claim 14, wherein the cell addition response message comprises information of the candidate cell added into the next generation telecommunication network, and wherein the cell addition response message does not comprise System Information Block (SIB) as the MSI (904a) is already broadcasted by the network apparatus (113).
